(19) United States
(12) Patent Application Publication
(10) Pub. No.: US 2026/0210856 A1
(43) Pub. Date: Jul. 23, 2026

(54) CONJUGATED OLIGOELECTROLYTES WITH BORON-DIPYRROMETHENE CORES AND METHODS THEREOF

(71) Applicant: National University of Singapore, Singapore (SG)

(72) Inventors: Guillermo Carlos BAZAN, Singapore (SG); Jiyu ZHU, Singapore (SG); Sarah COX-VAZQUEZ, Singapore (SG)

(73) Assignee: National University of Singapore, Singapore (SG)

(21) Appl. No.: 19/140,539

(22) PCT Filed: Dec. 12, 2023
(86) PCT No.: PCT/SG2023/050827

§ 371 Date: Jun. 18, 2025

(30) Foreign Application Priority Data
Dec. 20, 2022 (SG) 10202260505T

(51) Int. Cl. G01N 21/64; C07F 5/02; G01N 1/30

(52) U.S. Cl. CPC G01N 21/6428; C07F 5/027; G01N 1/30; G01N 2021/6439

(57) ABSTRACT

The present disclosure concerns a conjugated oligoelectrolytes, as exemplified in compound of Formula (I) or a salt or solvate thereof. The present disclosure also concerns a method of staining a cell membrane and/or lipid vesicle. The present disclosure also concerns a method of selectively staining a domain of a cell membrane and/or lipid vesicle, the domain having a higher viscosity relative to another region of the cell membrane and/or lipid vesicle.

### TECHNICAL FIELD

The present disclosure relates to conjugated oligoelectrolytes with boron-dipyrromethene cores and their methods of use thereof. In particular, the conjugated oligoelectrolytes are suitable for use as a membrane probe.

### BACKGROUND

The cell membrane is a biological membrane that separates and protects the interior of all cells from the outside environment. The cell membrane consists of a lipid bilayer, made up of two layers of phospholipids with cholesterols (a lipid component) interspersed between them, maintaining appropriate membrane fluidity at various temperatures. The membrane also contains membrane proteins, including integral proteins that span the membrane and serve as membrane transporters, and peripheral proteins that loosely attach to the outer (peripheral) side of the cell membrane, acting as enzymes to facilitate interaction with the cell's environment. Glycolipids embedded in the outer lipid layer serve a similar purpose. The cell membrane controls the movement of substances in and out of cells and organelles, being selectively permeable to ions and organic molecules. In addition, cell membranes are involved in a variety of cellular processes such as cell adhesion, ion conductivity, and cell signalling and serve as the attachment surface for several extracellular structures, including the cell wall and the carbohydrate layer called the glycocalyx, as well as the intracellular network of protein fibers called the cytoskeleton. In this regard, the physiology of the cell membrane is highly varied and complicated. New drugs may be developed with better understanding of the cell membrane.

In particular, lipid bilayer membranes are essential structural elements in cellular systems. Beyond compartmentalizing cellular components from the surrounding environment, they play important roles in many subtle, yet vital cellular functions. Some major examples include molecular transport, signal transmission, intercell communication, and cell-cell and cell-extracellular matrix interactions. Membrane dyes have therefore been developed to visualize membranes and to gain insights into their properties and functions, such as inter-organelle communication and membrane trafficking. Fluorescent probes that “light up” membranes, however, typically provide information on location in space with little additional insights into relevant biophysical properties. For example, membrane tension is a dynamic physical property that plays an essential role in regulating cell division and remodelling. Physics-centric tools, such as micropipette aspiration, atomic force microscopy, and optical tweezers have been developed to examine mechanical properties and membrane tension. These approaches are invasive and difficult to configure for monitoring dynamic processes throughout a large population of cells. Chemical biology tools that interrogate tension in subcellular structures involve protein or DNA engineering, which are highly specific to the system under investigation. Only a few molecular fluorophores have been successfully reported to measure membrane tension of the plasma membrane or organelles within the cell. Of note is the Flipper series of reporters, which has opened opportunities to measure membrane tension of various organelles, intracellular vesicle formation, and osmotic shock response. Flipper probes comprise a hydrophobic chromophore that inserts into the bilayer and experiences different levels of planarization as a function of membrane tension. This intramolecular feature ultimately modulates polarization and fluorescence lifetimes.

Conjugated oligoelectrolytes (COEs) are a class of fluorescent molecules defined by a hydrophobic conjugated core bearing terminal polar ionic pendants. The hydrophobic backbone consisting of n-delocalized repeat units. The overall molecular structures are similar to the organization of hydrophilic and hydrophobic domains in lipid bilayers. As such, COEs can spontaneously intercalate and partition into membranes, driven by electrostatic and hydrophobic interactions between the COEs and the lipids. The affinity of certain cationic COEs towards negatively charged phospholipid bilayers has enabled diverse applications including bioelectrochemical systems, biosensing, and antimicrobial candidates. It has also been determined that membrane-intercalated COEs reside in a perpendicular orientation relative to the lipid bilayer plane. Upon partition into lipid bilayers from aqueous solution, the COEs emission will enhance significantly. This “light up” mechanism will confer COE dyes to achieve a high signal-to-noise ratio upon localizing within the hydrophobic environment of lipid bilayers.

There is a lack of molecules that target the cell membrane or lipid bilayer. There is further a need for molecules with specificity for certain regions of the lipid bilayer.

Accordingly, it would be desirable to overcome or ameliorate at least one of the above-described problems.

### SUMMARY

The present disclosure relates to a compound of Formula (I) or a salt or solvate thereof:

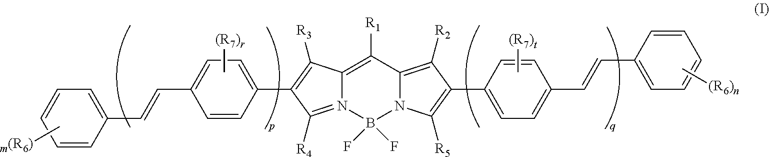

wherein
R₁ is selected from optionally substituted alkyl, optionally substituted aryl, or optionally substituted heteroaryl;
R₂, R₃, R₄, R₅ are each independently selected from H or optionally substituted alkyl; each R₆ is independently selected from halogen, optionally substituted alkyl, optionally substituted alkenyl, optionally substituted alkynyl, optionally substituted alkoxy, optionally substituted alkenyloxy, optionally substituted alkynyloxy, optionally substituted acyl, optionally substituted oxyacyl, optionally substituted acyloxy, optionally substituted amino, optionally substituted aminoacyl, optionally substituted acylamino, optionally substituted aminoacyloxy, optionally substituted oxyacylamino, optionally substituted oxyacyloxy or optionally substituted thio or optionally substituted phosphoryl;
each R₂ is independently selected from halogen, cyano, optionally substituted alkyl, optionally substituted alkenyl or optionally substituted alkynyl;
m and n are independently an integer selected from 1 to 5;
p and q are independently an integer selected from 1 to 3; and
r and t are independently an integer selected from 0 to 4.

In some embodiments, R₁ is optionally substituted aryl.

In some embodiments, the optional substituent on R₁ is selected from alkyl, alkoxy, amino, cyano, or nitro.

In some embodiments, R₂, R₃, R₄, R₅ are each optionally substituted alkyl.

In some embodiments, R₂, R₃, R₄, R₅ are each independently selected from methyl, ethyl, propyl, t-butyl or n-butyl.

In some embodiments, each R₆ is independently selected from optionally substituted alkyl, or optionally substituted alkoxy.

In some embodiments, each R₆ is independently selected from alkyl and alkoxy, each optionally substituted with amino, or alkylamino.

In some embodiments, each R₆ is independently C₃-C₈ alkoxy substituted with amino, or alkylamino.

In some embodiments, n is 3 and m is 3.

In some embodiments, R₆ is at a meta and/or para position relative to the ethylene moiety.

In some embodiments, the compound of Formula (I) is a compound of Formula (Ia):

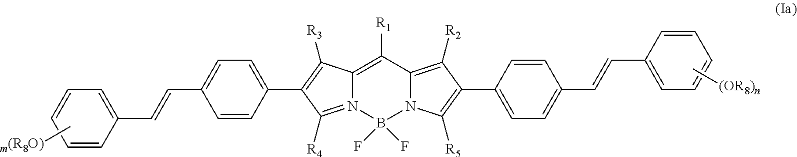

wherein
R₁ is selected from optionally substituted alkyl, optionally substituted aryl, or optionally substituted heteroaryl;
R₂, R₃, R₄, R₅ are each independently selected from H or optionally substituted alkyl;
each R₆ is independently optionally substituted alkyl;
n is an integer selected from 1 to 5; and
m is an integer selected from 1 to 5.

In some embodiments, each R₆ is independently C₄-C₈ alkyl optionally substituted with amino.

In some embodiments, the compound of Formula (I) is selected from

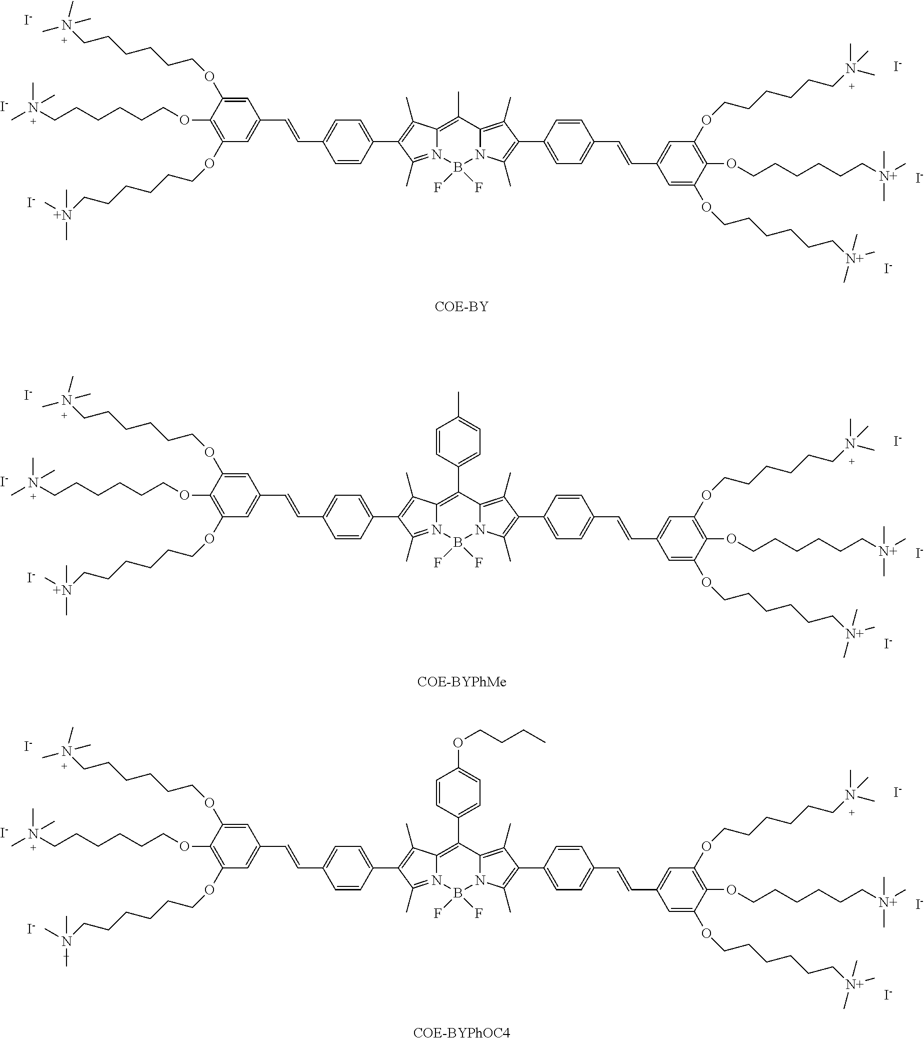

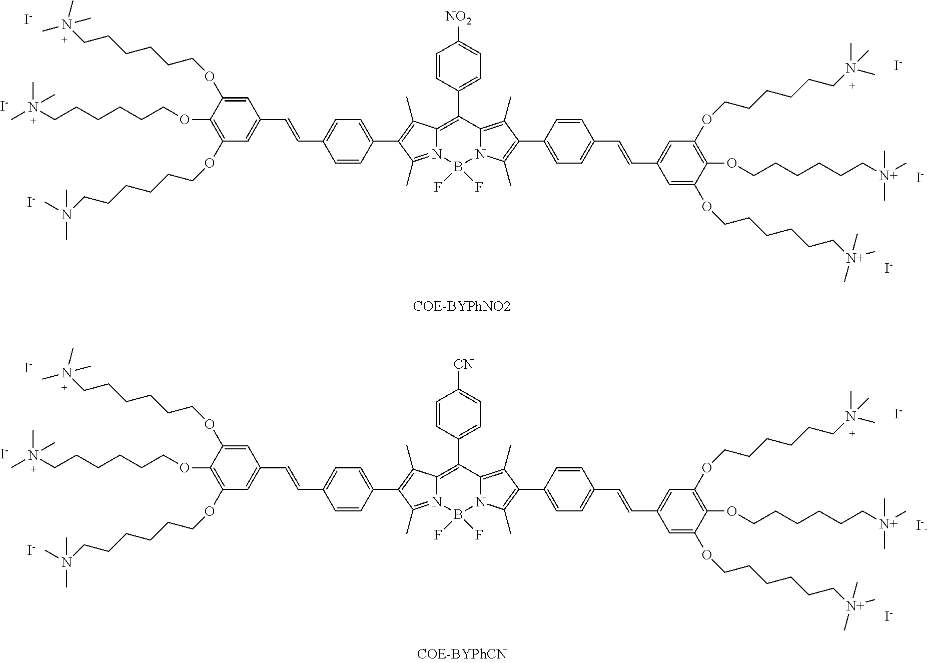

The present disclosure also relates to a method of staining a cell membrane and/or lipid vesicle, comprising contacting the compound of Formula (I) or a salt or solvate thereof with the cell membrane and/or lipid vesicle.

The present disclosure also relates to a method of selectively staining a domain of a cell membrane and/or lipid vesicle, the domain having a higher viscosity relative to another region of the cell membrane and/or lipid vesicle, comprising contacting the compound of Formula (I) or a salt or solvate thereof with the cell membrane and/or lipid vesicle.

In some embodiments, the domain of the cell membrane and/or lipid vesicle is characterised by a presence of lipoprotein, glycolipoprotein and/or cholesterol.

In some embodiments, the domain of the cell membrane and/or lipid vesicle having a having a higher relative viscosity is characterised by a relatively higher density of lipoprotein and/or cholesterol.

In some embodiments, the cell membrane is from an adherent cell.

In some embodiments, the contact period is about 1 min to about 12 days.

In some embodiments, the compound of Formula (I) is characterised by a fluorescence lifetime which is linearly correlated with a viscosity of the domain.

In some embodiments, the compound of Formula (I) is characterised by a fluorescence lifetime of about 1.1 ns to about 1.8 ns at a viscosity of about 1200 cP.

The present disclosure also relates to a method of detecting a cell membrane and/or a lipid vesicle using a fluorescence detector, comprising:
a) contacting a compound of Formula (I) or a salt or solvate thereof with the cell membrane and/or lipid vesicle; and
b) passing the cell membrane and/or lipid vesicle through the fluorescence detector.

The present disclosure also relates to a method of tracking endocytosis in a cell, comprising:
a) contacting a compound of Formula (I) or a salt or solvate thereof according to any one claims 1 to 13 with the cell; and
b) passing the cell through a fluorescence detector;
wherein the compound of Formula (I) is configured to exhibit an increasing fluorescence emission lifetime as it is internalised into the cell.

The present disclosure also relates to a flow system for detecting and/or quantifying cells membrane and/or lipid vesicle, comprising:
a) a compound of Formula (I) or a salt or solvate thereof for labelling the cell membrane and/or lipid vesicle;
b) an inlet for introducing the labelled cell membrane and/or lipid vesicle into the flow system;
c) a detection means in fluid communication with the inlet for detecting a fluorescence emission from the labelled cell membrane and/or lipid vesicle; and
d) optionally a counter means for quantifying the labelled cell membrane and/or lipid vesicle.

### BRIEF DESCRIPTION OF THE DRAWINGS

Embodiments of the present invention will now be described, by way of non-limiting example, with reference to the drawings in which:

FIG. 1 shows (a) normalized Absorption and Emission Spectra of 1 μM COE-BYPhMe in PBS and (b) Emission spectra of 1 μM COE-BYPhMe before and after intercalation in 500 μM POPC SUVs.

FIG. 2 shows (a) fluorescence lifetime measurements of 1 μM COE-BYPhMe in water:glycerol mixtures of varying viscosities. (b) correlation of viscosity vs fluorescent lifetime (R2=0.98) (c) fluorescence lifetime measurements of 1 μM COE-S5 in water:glycerol mixtures of varying viscosities. (d) chemical structures of COE-BYPhMe and COE-S5.

FIG. 3 shows emission intensity of 0.5 μM (a) COE-BYPhMe and (b) COE-BYPhOC4 in the presence of different analytes at a concentration of 0.5 mg/mL.

FIG. 4 shows fluorescent lifetime measurements of 0.5 μM (a) COE-BYPhMe and (b) COE-BYPhOC4 in the presences of different analytes at a concentration of 0.5 mg/mL.

FIG. 5 shows confocal micrographs of A549 cells after stained by 0.75 μM COE-BYPhMe and Hoechst 33342 (nucleus) (a) COE-BYPhMe channel, (b) COE-BYPhMe and Hoechst 33342 overlay, (c) Hoechst 33342 channel, (d) COE-BYPhMe, Hoechst 33342 and brightfield overlay. The scale bars are 10 μm.

FIG. 6 shows (a) confocal and FLIM imaging of A549 cells stained with COE-S6 (top) and COE-BYPhMe (bottom) for 24 hours.

FIG. 7 shows flow cytometry plots of PC-3 Exosomes stained with COE-BY compounds.

FIG. 8 shows (a) comparison of previous COEs designed for membrane modification (COE-S5) and bioimaging applications (COE-BBT) and COE-BY in this work. (b) Localization of COE-BY molecules within the lipid bilayer and their applicability for membrane tension imaging. (c) Chemical structures of, and (d) synthetic routes to the COE-BY series.

FIG. 9 shows (a) normalized absorption spectra of COE-BY series in PBS. (b) Normalized emission spectra of COE-BY series with SUVs. (c) Emission spectra of 1 □M COE-BYPhOC4 with/without SUVs. (d) Fluorescence images of GUV stained with COE-BYPhOC4 and DOPE-Cy5 under normal light and polarized light (COE-BYPhOC4: λₑₓ=531 nm, λₑₘ=540-600 nm; DOPE-Cy5: λₑₓ=633 nm, λₑₘ=650 long pass filter), scale bar: 5 μm. (e) Photograph of COE-BY series in PBS and SUVs under 365 nm illumination. (f) Time dependent fluorescence intensity increase of COE-BYPhOC4 inserting into lipid bilayers at 590 nm. (g) Fluorescence intensity at 590 nm from COE-BYPhOC4 in SUV solutions of different concentrations. (h) Cryo-EM images of SUVs stained with COE-BYPhOC4.

FIG. 10 shows (a) simulated bandgaps of COE-BY series. DFT-calculated HOMO and LUMO energy levels using the B3LYP/6-31G (d,p) method. (b) Relationship between viscosity and lifetime for the COE-BY molecules compared to COE-S5. Lines represent best fit to a linear regression model (c) Experimentally determined two-photon absorption cross sections in SUVs.

FIG. 11 shows comparison of the brightness of the different COE-BY molecules upon staining of HeLa cells as analyzed with flow cytometry.

FIG. 12 shows (a) confocal image of MDCK cells stained with 1 μM COE-BYPhOC4 for 10 min (plasma membrane, red) with labeled early endosomes (green). (b) Confocal image of A549 cells stained with 1 μM COE-BYPhOC4. Confocal images of (c) A549 and (d) HeLa cells. Cells were prestained with COE-BYPhOC4 (red) for 4 hours and then stained with commercial plasma membrane dye CellMask Deep Red (blue and green, respectively) for 5 min. (e) Confocal images for time-dependent colocalization experiments. HeLa cells were stained with 1 μM COE-BYPhOC4 with different incubation times (2 h, 8 h, 24 h and 48 h). Cells were imaged in multiple channels to collect fluorescence signals from COE-BYPhOC4 and other commercial organelle dyes. Red: COE-BYPhOC4; the first column green: CellLight Early Endosome-GFP; the second column green: CellLight Late Endosome-GFP; the third column deep blue: CellLight Lysosomes-GFP; the fourth column sky blue: HCS LipidTOX™ Deep Red; the fifth column yellow: MitoTracker Deep Red. Scale bar: 5 μm.

FIG. 13 shows relative fluorescence intensities of A549 (a) and HeLa (b) cells stained with COE-BYPhOC4 for 3 h. The signals were collected through flow cytometry. Cells were pretreated with various endocytic inhibitors or low temperature (4° C.). CTRL: control; GEN: aenistein; CHL: chlorpromazine. N=5. (c) Confocal images of HeLa cells with the same treatment. Scale bar: 5 μm.

FIG. 14 shows overlay of phasor plots from FLIM analysis of GUVs with varying compositions (DOPC, DOPC/Chol, DOPC/SM/Chol, and SM/Chol) stained with 1 μM COE-BYPhOC4. Inset: Representative FLIM images for the stained GUVs (n=3).

FIG. 15 shows response of COE-BYPhOC4 fluorescence lifetime to osmotic shocks on HeLa cells. (a) 2P-FLIM images and (b) phasor plots of HeLa cells after hyper or hypoosmotic shocks. HeLa cells were pre-stained with COE-BYPhOC4 for 6 hours. Scale bar: 5 μm. (c) Table of average lifetime τ_{w} in solutions of different osmotic pressures.(d) Normalized histogram of lifetime distribution under different osmotic shocks. (e) Average weighted lifetime (τ_{w}) as a function of osmolarity (Π) with linear curve fit (n=20). Initial osmotic pressure is 330 mOsm (black dash line).

FIG. 16 shows (a) two photon FLIM images and (b) phasor plots of HeLa cells stained with COE-BYPhOC4 for 0.5 h, 2 h, 4 h, 8 h, and 24 h. White arrows indicate selected vesicles that were magnified below for comparison. Scale bar: 10 μm. (c) Box plots of COE lifetime showcasing the relative distribution of each population present within the cells. Boxes and whiskers mark the 25^{th}/75^{th} and 10^{th}/90^{th} quartiles respectively (d) Scheme highlighting how the average lifetime of COE-BYPhOC4 changes as it progresses through the endocytic pathway.

### DETAILED DESCRIPTION

“Alkyl” refers to monovalent alkyl groups which may be straight chained or branched and preferably have from 1 to 10 carbon atoms or more preferably 1 to 6 carbon atoms. Examples of such alkyl groups include methyl, ethyl, n-propyl, iso-propyl, n-butyl, iso-butyl, n-hexyl, and the like.

“Alkenyl” refers to a monovalent alkenyl group which may be straight chained or branched and preferably have from 2 to 10 carbon atoms and more preferably 2 to 6 carbon atoms and have at least 1 and preferably from 1-2, carbon to carbon, double bonds. Examples include ethenyl (—CH═CH₂), n-propenyl (—CH₂CH═CH₂), iso-propenyl (—C(CH₃)═CH₂), but-2-enyl (—CH₂CH═CHCH₃), and the like.

“Alkynyl” refers to alkynyl groups preferably having from 2 to 10 carbon atoms and more preferably 2 to 6 carbon atoms and having at least 1, and preferably from 1-2, carbon to carbon, triple bonds. Examples of alkynyl groups include ethynyl (—C≡CH), propargyl
(—CH₂C≡CH), pent-2-ynyl (—CH₂C≡CCH₂—CH₃), and the like.

“Alkoxy” refers to the group alkyl-O— where the alkyl group is as described above. Examples include, methoxy, ethoxy, n-propoxy, iso-propoxy, n-butoxy, tert-butoxy, sec-butoxy, n-pentoxy, n-hexoxy, 1,2-dimethylbutoxy, and the like.

“Alkenyloxy” refers to the group alkenyl-O— wherein the alkenyl group is as described above.

“Alkynyloxy” refers to the group alkynyl-O— wherein the alkynyl groups is as described above.

“Halo” or “halogen” refers to fluoro, chloro, bromo and iodo.

“Acyl” refers to groups H—C(O)—, alkyl-C(O)—, cycloalkyl-C(O)—, aryl-C(O)—, heteroaryl-C(O)— and heterocyclyl-C(O)—, where alkyl, cycloalkyl, aryl, heteroaryl and heterocyclyl are as described herein.

“Oxyacyl” refers to groups HOC(O)—, alkyl-OC(O)—, cycloalkyl-OC(O)—, aryl-OC(O)—, heteroaryl-OC(O)—, and heterocyclyl-OC(O)—, where alkyl, cycloalkyl, aryl, heteroaryl and heterocyclyl are as described herein.

“Amino” refers to the group —NR″R″ where each R″ is independently hydrogen, alkyl, cycloalkyl, aryl, heteroaryl, and heterocyclyl and where each of alkyl, cycloalkyl, aryl, heteroaryl and heterocyclyl is as described herein.

“Aminoacyl” refers to the group —C(O)NR″R″ where each R″ is independently hydrogen, alkyl, cycloalkyl, aryl, heteroaryl, and heterocyclyl and where each of alkyl, cycloalkyl, aryl, heteroaryl and heterocyclyl is as described herein.

“Acylamino” refers to the group —NR″C(O)R″ where each R″ is independently hydrogen, alkyl, cycloalkyl, aryl, heteroaryl and heterocyclyl and where each of alkyl, cycloalkyl, aryl, heteroaryl, and heterocyclyl are as described herein.

“Acyloxy” refers to the groups —OC(O)-alkyl, —OC(O)-aryl, —C(O)O-heteroaryl, and —C(O)O-heterocyclyl where alkyl, aryl, heteroaryl and heterocyclyl are as described herein.

“Aminoacyloxy” refers to the groups —OC(O)NR″-alkyl, —OC(O)NR″-aryl, —OC(O)NR″-heteroaryl, and —OC(O)NR″-heterocyclyl where R″ is independently hydrogen, alkyl, cycloalkyl, aryl, heteroaryl, and heterocyclyl and where each of alkyl, cycloalkyl, aryl, heteroaryl and heterocyclyl is as described herein.

‘Cyano’ refers to the group —CN.

“Oxyacylamino” refers to the groups —NR″C(O)O-alkyl, —NR″C(O)O-aryl, —NR″C(O)O-heteroaryl, and NR″C(O)O-heterocyclyl where R″ is independently hydrogen, alkyl, cycloalkyl, aryl, heteroaryl, and heterocyclyl and where each of alkyl, cycloalkyl, aryl, heteroaryl and heterocyclyl is as described herein.

“Oxyacyloxy” refers to the groups —OC(O)O-alkyl, —O—C(O)O-aryl, —OC(O)O— heteroaryl, and —OC(O)O-heterocyclyl where alkyl, cycloalkyl, aryl, heteroaryl, and heterocyclyl are as described herein.

“Thio” refers to groups H—S—, alkyl-S—, cycloalkyl-S—, aryl-S—, heteroaryl-S—, and heterocyclyl-S—, where alkyl, cycloalkyl, aryl, heteroaryl and heterocyclyl are as described herein.

“Phosphoryl” refers to the groups —P(O)(R″′)(OR″″) where R″′ represents OR″″ or is hydroxyl, alkyl or amino and R″″ is alkyl, cycloalkyl, aryl or arylalkyl, where alkyl, amino, alkenyl, aryl, cycloalkyl, and arylalkyl are as described herein.

“Aryl” refers to an unsaturated aromatic carbocyclic group having a single ring (eg. phenyl) or multiple condensed rings (eg. naphthyl or anthryl), preferably having from 6 to 14 carbon atoms. Examples of aryl groups include phenyl, naphthyl and the like.

“Heteroaryl” refers to a monovalent aromatic heterocyclic group which fulfils the HUckel criteria for aromaticity (ie. contains 4n+2 n electrons) and preferably has from 2 to 10 carbon atoms and 1 to 4 heteroatoms selected from oxygen, nitrogen, selenium, and sulfur within the ring (and includes oxides of sulfur, selenium and nitrogen). Such heteroaryl groups can have a single ring (eg. pyridyl, pyrrolyl or N-oxides thereof or furyl) or multiple condensed rings (eg. indolizinyl, benzoimidazolyl, coumarinyl, quinolinyl, isoquinolinyl or benzothienyl).

Examples of heteroaryl groups include, but are not limited to, oxazole, pyrrole, imidazole, pyrazole, pyridine, pyrazine, pyrimidine, pyridazine, indolizine, isoindole, indole, indazole, purine, isoquinoline, quinoline, phthalazine, naphthylpyridine, quinoxaline, quinazoline, cinnoline, pteridine, carbazole, carboline, phenanthridine, acridine, phenanthroline, isothiazole, phenazine, isoxazole, isothiazole, phenoxazine, phenothiazine, thiazole, thiadiazoles, oxadiazole, oxatriazole, tetrazole, thiophene, benzo[b]thiophene, triazole, imidazopyridine and the like.

“Arylene” refers to a divalent aryl group wherein the aryl group is as described above.

“Heteroarylene” refers to a divalent heteroaryl group wherein the aryl group is as described above.

“Heterocyclyl” refers to a monovalent saturated or unsaturated group having a single ring or multiple condensed rings, preferably from 1 to 8 carbon atoms and from 1 to 4 hetero atoms selected from nitrogen, sulfur, oxygen, selenium or phosphorous within the ring. The most preferred heteroatom is nitrogen. It will be understood that where, for instance, R₂ or R′ is an optionally substituted heterocyclyl which has one or more ring heteroatoms, the heterocyclyl group can be connected to the core molecule of the compounds of the present invention, through a C—C or C-heteroatom bond, in particular a C—N bond.

Examples of heterocyclyl and heteroaryl groups include, but are not limited to, oxazole, pyrrole, imidazole, pyrazole, pyridine, pyrazine, pyrimidine, pyridazine, indolizine, isoindole, indole, indazole, purine, quinolizine, isoquinoline, quinoline, phthalazine, naphthylpyridine, quinoxaline, quinazoline, cinnoline, pteridine, carbazole, carboline, phenanthridine, acridine, phenanthroline, isothiazole, phenazine, isoxazole, isothiazole, phenoxazine, phenothiazine, imidazolidine, imidazoline, piperidine, piperazine, indoline, phthalimide, 1,2,3,4-tetrahydroisoquinoline, 4,5,6,7-tetrahydrobenzo[b]thiophene, thiazole, thiadiazoles, oxadiazole, oxatriazole, tetrazole, thiazolidine, thiophene, benzo[b]thiophene, morpholino, piperidinyl, pyrrolidine, tetrahydrofuranyl, triazole, and the like.

“Optionally substituted” is taken to mean that a group may or may not be further substituted or fused (so as to form a condensed polycyclic group) with one or more groups selected from hydroxyl, acyl, alkyl, alkoxy, alkenyl, alkenyloxy, alkynyl, alkynyloxy, amino, aminoacyl, thio, arylalkyl, arylalkoxy, aryl, aryloxy, carboxyl, acylamino, cyano, halogen, nitro, phosphono, sulfo, phosphorylamino, phosphinyl, heteroaryl, heteroarylalkyl, heteroaryloxy, heterocyclyl, heterocyclylalkyl, heterocyclyloxy, oxyacyl, oxime, oxime ether, hydrazone, oxyacylamino, oxysulfonylamino, aminoacyloxy, trihalomethyl, trialkylsilyl, pentafluoroethyl, trifluoromethoxy, difluoromethoxy, trifluoromethanethio, trifluoroethenyl, mono- and di-alkylamino, mono- and di-(substituted alkyl)amino, mono- and di-arylamino, mono- and di-heteroarylamino, mono- and di-heterocyclyl amino, and unsymmetric di-substituted amines having different substituents selected from alkyl, aryl, heteroaryl and heterocyclyl, and the like, and may also include a bond to a solid support material, (for example, substituted onto a polymer resin). For instance, an “optionally substituted amino” group may include amino acid and peptide residues.

“Hydrophilic” refers to molecules or moieties which have a greater affinity for, and thus solubility in, water as compared to organic solvents. For example, the hydrophilicity of a compound can be quantified by measuring its partition coefficient between water (or a buffered aqueous solution) and a water-immiscible organic solvent, such as octanol, ethyl acetate, methylene chloride, or methyl tert-butyl ether. If after equilibration a greater concentration of the compound is present in the water than in the organic solvent, then the compound may be considered to be hydrophilic.

“Hydrophobic” refers to molecules or moieties which have a greater affinity for, and thus solubility in, organic solvents as compared to water. For example, the hydrophobicity of a compound can be quantified by measuring its partition coefficient between water (or a buffered aqueous solution) and a water-immiscible organic solvent, such as octanol, ethyl acetate, methylene chloride, or methyl tert-butyl ether. If after equilibration a greater concentration of the compound is present in the organic solvent than in the water, then the compound may be considered to be hydrophobic.

Conjugated oligoelectrolytes (COEs) are a class of molecules defined by a hydrophobic conjugated core bearing terminal polar ionic pendants. The hydrophobic and hydrophilic moieties in COEs may be rationally designed such that they mirror the organization of hydrophilic and hydrophobic domains in lipid bilayers. This structural design typically involves only unbranched internal structures with charged groups at the two termini so that it favours the spontaneous intercalation of COEs into cellular membranes, which is driven by electrostatic and hydrophobic interactions between the COEs and the lipids.

Characteristically, the fluorescence emission of COEs enhance significantly upon their intercalation into lipid bilayers from the aqueous solution. This “light up” mechanism confers a high signal-to-noise ratio for COEs when they are localized within the more hydrophobic environment of lipid bilayers. Additionally, COEs have a distinct chemical structure from many commercially available lipophilic dyes, which usually contain a surfactant-like structure, i.e., one side of the molecule is hydrophobic, and the other side is hydrophilic. These surfactant-like structures will induce micelle-like aggregation in the aqueous solutions. For example, the commonly used membrane dye, PKH-26, has been shown to form aggregates, which have a similar size and fluorescence intensity compared to small particles such as the exosomes, thereby leading to false-positive signals. These phenomenona can be avoided in the case of COEs given that their emission has been shown to greatly intensify after intercalation into the lipid bilayer; i.e. high signal to noise ratio.

The present disclosure is predicated on the understanding that the intrinsic emissive nature and modular designability from simple subunits make COEs a flexible molecular platform for the design of bioimaging probes.

In particular, membrane viscosity has been shown to play a role in a variety of cell functions and changes in viscosity have been observed in diseases including cancer. Without wanting to be bound by theory, the inventors believe that the conjugated segment may be modified such that if it still spans the bilayer. This geometric feature may provide a way to design COEs that can respond to the membrane tension of the whole lipid bilayer. For example, COEs with boron-dipyrromethene (BODIPY) moieties may show sensitive to local viscosities. BODIPY moieties may be incorporated into the hydrophobic region of the COE cores, at the central junction of the conjugated framework (COE-BYs). The COE-BYs are thus made sensitive to viscosity of the environment surrounding the molecule, and could therefore confer optical read-out on the local environment within the lipid bilayer. The optical properties of the fluorophore could be tailored by changing the nature of the substituents on the phenyl ring on the BODIPY unit. These new chemical compositions may act as a new type of viscosity sensitive fluorescent membrane dye.

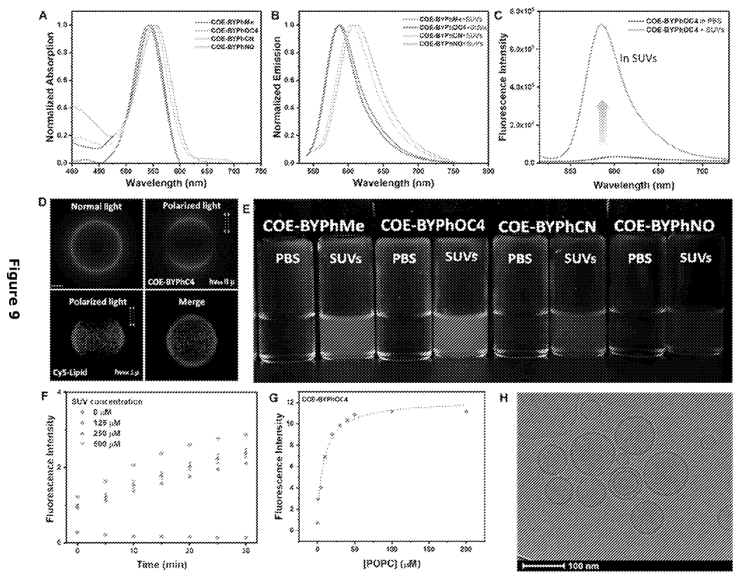

Accordingly, different BODIPY fragments were introduced containing aryl substituents at the meso position with electron-withdrawing (EWG, —NO2/—CN) or electron-donating (EDG, —OR, -Me) groups (FIG. 8C). The molecule with the most efficient emission, namely COE-BYPhOC4, was successfully used to visualize changes in membrane tension throughout the cellular endocytic process. By taking advantage of two-photon fluorescence lifetime imaging microscopy (2P-FLIM), it is shown that the average membrane tension of the vesicles increases as they pinch off from the plasma membrane and subsequently mature. COE-BYPhOC4 was also capable of distinguishing between vesicle subpopulations with different membrane tensions at a specific timepoints, reflecting different degrees of lipid order between early and late endosomes. Furthermore, the observation of a distribution of lifetimes within a single punctum at each time point suggest a multiphase composition of these vesicles. This COE-based imaging capability underscores possible avenues for developing new environmentally sensitive lipid-bilayer optical probes useful for studying membrane tension in environments ranging from live cells to extracellular vesicles undergoing different biological processes.

Accordingly, the present disclosure relates to a compound of Formula (I) or a salt or solvate thereof:

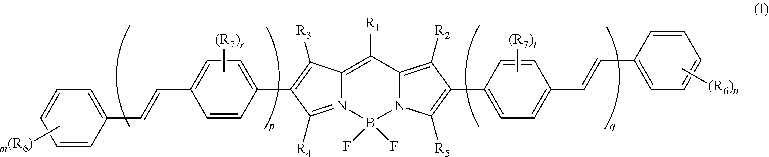

wherein
R₁ is selected from optionally substituted alkyl, optionally substituted aryl, or optionally substituted heteroaryl;
R₂, R₃, R₄, R₅ are each independently selected from H or optionally substituted alkyl; each R₆ is independently selected from halogen, optionally substituted alkyl, optionally substituted alkenyl, optionally substituted alkynyl, optionally substituted alkoxy, optionally substituted alkenyloxy, optionally substituted alkynyloxy, optionally substituted acyl, optionally substituted oxyacyl, optionally substituted acyloxy, optionally substituted amino, optionally substituted aminoacyl, optionally substituted acylamino, optionally substituted aminoacyloxy, optionally substituted oxyacylamino, optionally substituted oxyacyloxy or optionally substituted thio or optionally substituted phosphoryl;
each R₇ is independently selected from halogen, cyano, optionally substituted alkyl, optionally substituted alkenyl or optionally substituted alkynyl;
m and n are independently an integer selected from 1 to 5;
p and q are independently an integer selected from 1 to 3; and
r and t are independently an integer selected from 0 to 4.

The compound of Formula (I) has a substantially linear topology. The topology refers to a molecular structure of a compound within the constraints of three-dimensional (3D) space. Such linear topology has two nodes as the termini without any junction nodes. The linear topology is advantageous for facilitating lipid membrane intercalation.

The compounds of Formula (I) are linear in order to accommodate its position within the lipid bilayer. In this regard, the phenyl moieties are in a trans (or E) configuration about the alkenyl moiety.

In some embodiments, the compounds are not branched; i.e. the monomeric units only extend along a single chain. This however does not exclude the monomeric units from being optionally substituted. In some embodiments, the compounds of Formula (I) are symmetrical in nature. The symmetry of a compound can be described by at least one of the 32 point groups. A Point Group describes all the symmetry operations that can be performed on a molecule that result in a conformation indistinguishable from the original. In this regard, in some embodiments, the compounds of Formula (I) have a C₂ᵥ point group.

It was found that Rₑ may rotate under different environment to affect the photophysical properties of the compound of Formula (I) which confer environment sensitivity.

In some embodiments, R₁ is selected from optionally substituted alkyl, or optionally substituted aryl. In some embodiments, R₁ is selected from optionally substituted C₁-C₅ alkyl, or optionally substituted aryl. In some embodiments, R₁ is optionally substituted aryl. In some embodiments, R₁ is optionally substituted phenyl.

In some embodiments, the optional substituent on R₁ is selected from halo, alkyl, alkenyl, alkoxy, alkenyloxy, amino, cyano, or nitro. In some embodiments, the optional substituent on R₁ is selected from, alkyl, alkoxy, amino, cyano, or nitro.

In some embodiments, R₂, R₃, R₄, R₅ are each independently H. In some embodiments, R₂, R₃, R₄, R₅ are each optionally substituted alkyl. In some embodiments, R₂, R₃, R₄, R₅ are each independently selected from methyl, ethyl, propyl, t-butyl or n-butyl.

In some embodiments, each R₆ is independently selected from halogen, optionally substituted alkyl, optionally substituted alkenyl, optionally substituted alkoxy, optionally substituted alkenyloxy, optionally substituted acyl, optionally substituted oxyacyl, optionally substituted acyloxy, optionally substituted amino, optionally substituted aminoacyl, or optionally substituted acylamino. In some embodiments, each R₆ is independently selected from optionally substituted alkyl, optionally substituted alkoxy, optionally substituted oxyacyl, optionally substituted acyloxy, optionally substituted aminoacyl, or optionally substituted acylamino. In some embodiments, each R₆ is independently selected from optionally substituted alkyl, or optionally substituted alkoxy. In some embodiments, each R₆ is independently selected from optionally substituted C₂-C₁₂ alkyl, or optionally substituted C₂-C₁₂ alkoxy. In some embodiments, each R₆ is independently selected from alkyl and alkoxy, each optionally substituted with amino, or alkylamino. In some embodiments, R₆ is independently C₃-C₈ alkoxy substituted with amino, or alkylamino.

In some embodiments, each R₇ is independently selected from halogen, cyano, optionally substituted alkyl, or optionally substituted alkenyl. In some embodiments, each R₇ is independently selected from halogen, cyano, or optionally substituted alkyl. In some embodiments, each R₇ is independently selected from halogen, cyano, or optionally substituted C₁-C₅ alkyl.

In some embodiments, n is an integer selected from 1 to 5. In some embodiments, n is an integer selected from 1 to 4. In some embodiments, n is an integer selected from 1 to 3. In some embodiments, n is 3.

In some embodiments, m is an integer selected from 1 to 5. In some embodiments, m is an integer selected from 1 to 4. In some embodiments, m is an integer selected from 1 to 3. In some embodiments, m is 3.

For compound of Formula (I) to have a balance of hydrophilic and hydrophobic properties to facilitate its intercalation within the lipid bilayer, at least one side chain should be present at each terminus of the backbone. In some embodiments, n is at least 1 and m is at least 1. In some embodiments, n is 3 and m is 3.

In some embodiments, R₆ is at a meta and/or para position relative to the ethylene moiety. In some embodiments, when n and/or m is 1, R₆ is at a meta position relative to the ethylene moiety. In some embodiments, when n and/or m is 1, R₆ is at a para position relative to the ethylene moiety.

In some embodiments, p is an integer selected from 1 to 3. In some embodiments, p is an integer selected from 1 to 2. In some embodiments, p is 1.

In some embodiments, q is an integer selected from 1 to 3. In some embodiments, q is an integer selected from 1 to 2. In some embodiments, q is 1.

In some embodiments, p is 1 and q is 1.

In some embodiments, r is an integer selected from 0 to 4. In some embodiments, r is an integer selected from 0 to 3. In some embodiments, r is an integer selected from 0 to 2. In some embodiments, r is 0.

In some embodiments, t is an integer selected from 0 to 4. In some embodiments, t is an integer selected from 0 to 3. In some embodiments, t is an integer selected from 0 to 2. In some embodiments, t is 0.

In some embodiments, r and t are 0.

In some embodiments, the compound of Formula (I) is a compound of Formula (Ia):

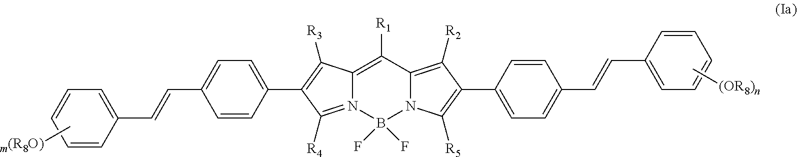

wherein
R₁ is selected from optionally substituted alkyl, optionally substituted aryl, or optionally substituted heteroaryl;
R₂, R₃, R₄, R₅ are each independently selected from H or optionally substituted alkyl;
each R₈ is independently optionally substituted alkyl;
n is an integer selected from 1 to 5; and
m is an integer selected from 1 to 5.

In some embodiments, each R₈ is independently C₅-C₈alkyl optionally substituted with amino.

The optional substituent at R₆ or R₈ may be a hydrophilic moiety. In other embodiments, the optional substituent at R₆ or R₈ is a charged moiety. Examples of hydrophilic and/or charged moieties are trialkylammonium halide. For example, the charged moiety can be trimethylammonium iodide. In this embodiment, R₆ or R₈ terminates with trimethylammonium, and thereby imparts a positive charge when substituted to R₇ or R₈ (for example, alkyl). Other cationic charged groups include but are not limited to pyridinium, pyrrolidinium, imidazolium, guanidinium, sulfonium, thiouronium, and phosphonium. Other anionic charged groups include but not limited to chlorate, sulphate, phosphate, acetate, carboxyl, hydroxide. The hydrophilic and/or charged moieties can also in zwitterionic form that contains both cationic and anionic charged groups through covalent bonds. The excess charges can be neutralized by acceptable cations or anions.

Basic nitrogen-containing groups may be quarternised with such agents as lower alkyl halide, such as methyl, ethyl, propyl, and butyl chlorides, bromides and iodides; dialkyl sulfates like dimethyl and diethyl sulfate; and others. Examples of the optional substituents on R₆ or R₈ can be selected from:

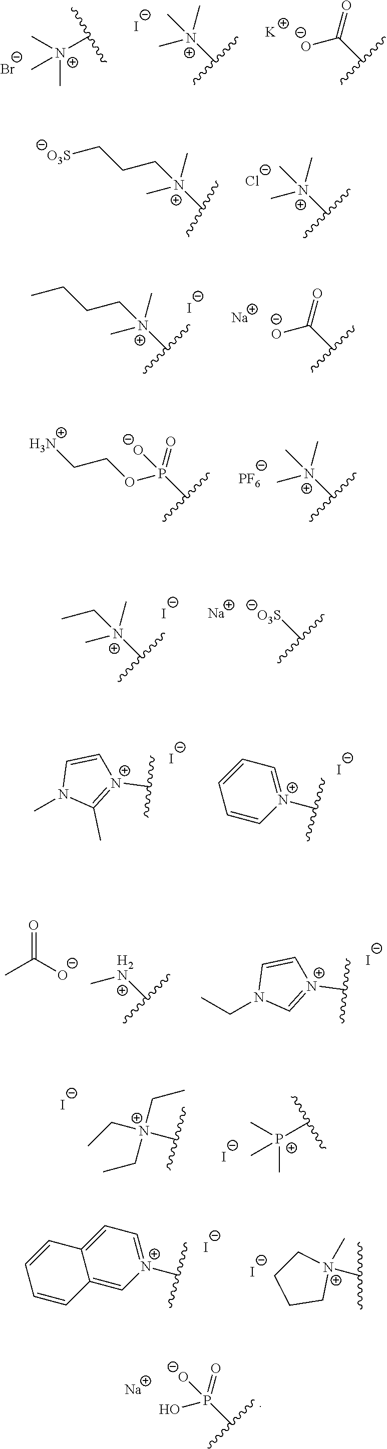

In some embodiments, the compound of Formula (I) or salt or solvate thereof is selected from

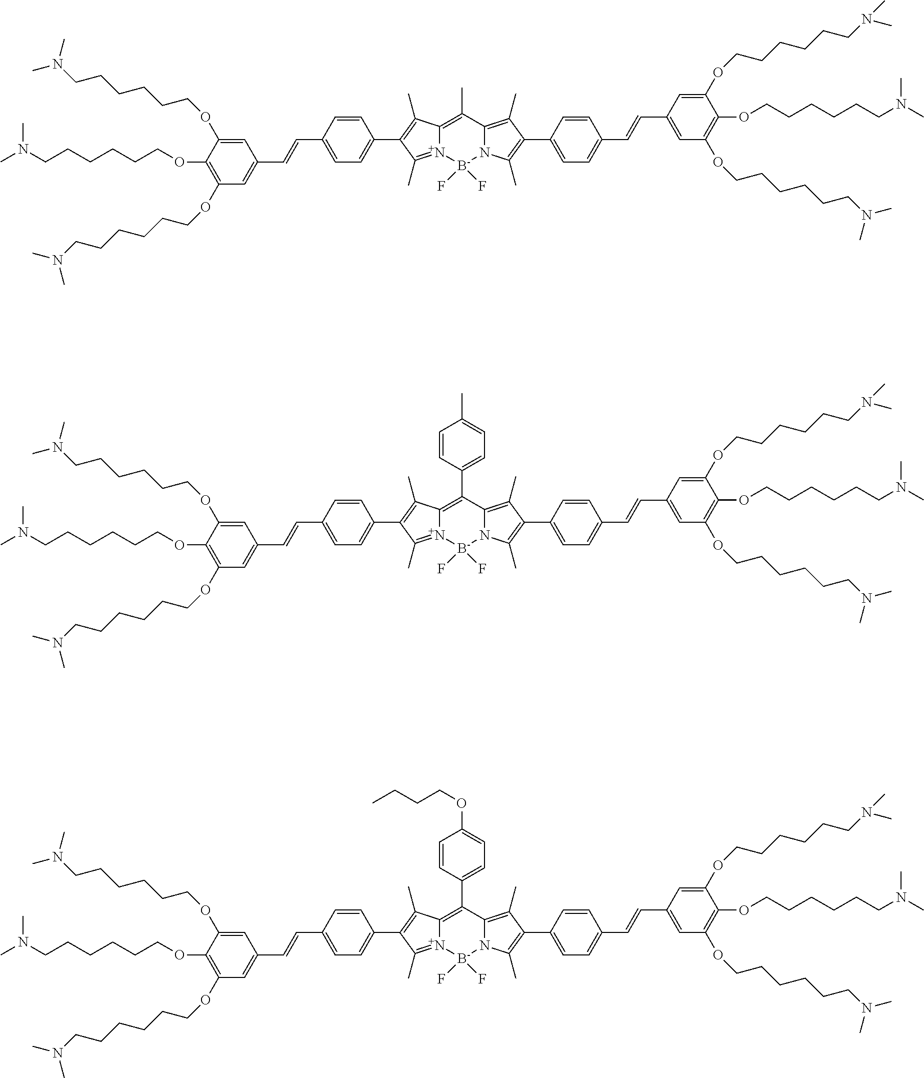

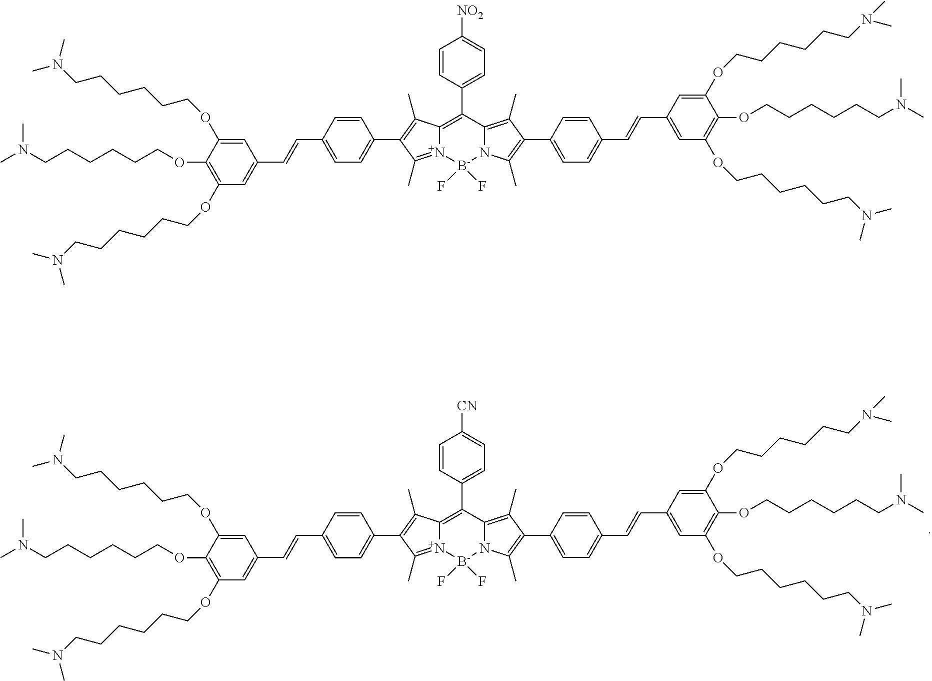

In some embodiments, the compound of Formula (I) is a salt thereof. The salt form can be a protonated salt, or can be generated by alkylating compound of Formula (I) with halocarbons. For example alkylhalide (such as CH₃Br or CH₃I) can be used. In some embodiments, the compound of Formula (I) or a salt or solvate thereof is a quaternary ammonium salt. In this regard, when R₁ is optionally substituted amino, each of R₁ can be alkylated to provide at least a positive charge at their respective ends.

For example, quaternary ammonium salts of compound of Formula (I) can be:

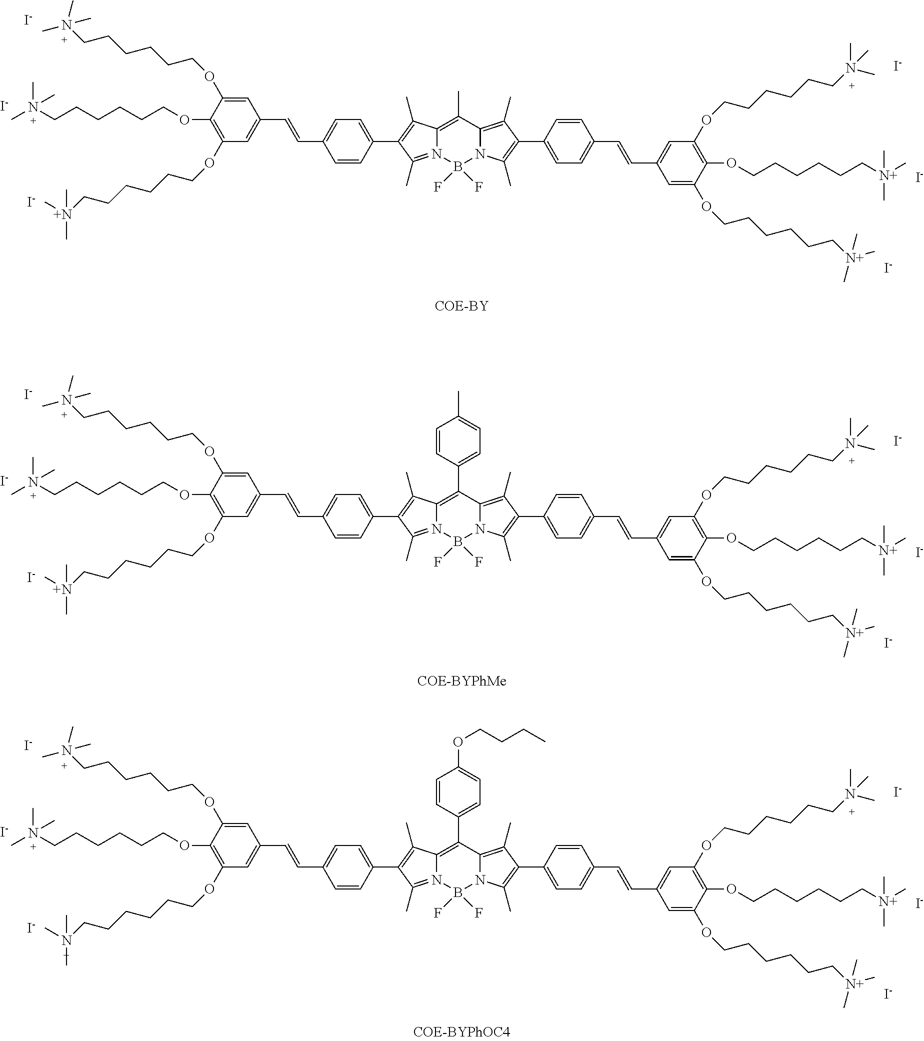

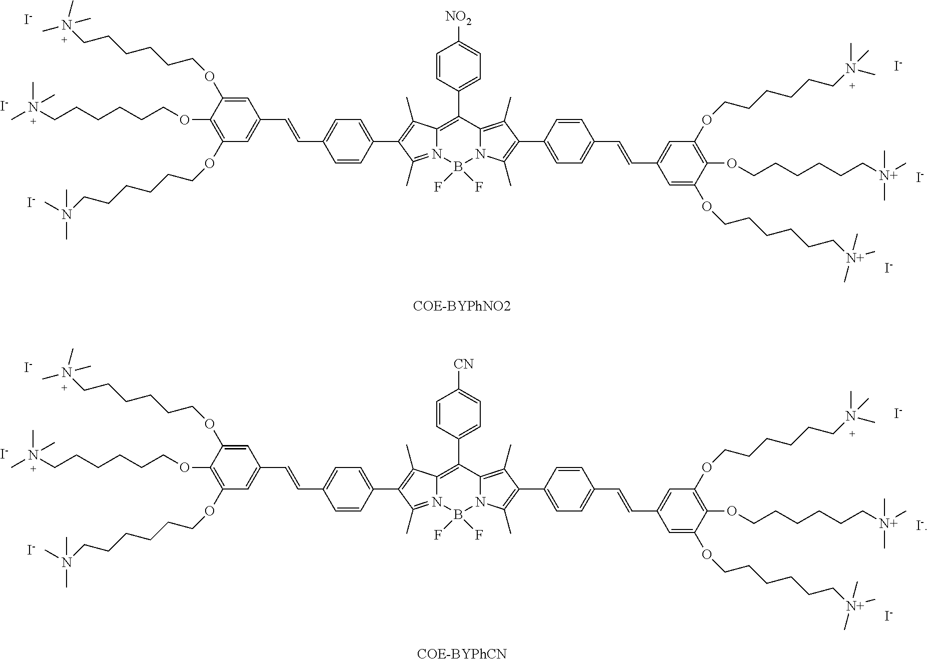

The compound of the invention may be in crystalline form either as the free compound or as a solvate (e.g. hydrate) and it is intended that both forms are within the scope of the present invention. Methods of solvation are generally known within the art.

The compounds of the present invention can be provided as a solid or as a solution. For example, the compound can be provided as a lyophilised powder.

The compounds of the present invention can be provided as a composition. The composition can comprise the compound in a polar medium as a single entity. As used herein, ‘polar medium’ includes polar protic and polar aprotic solvents. Polar solvents have large dipole moments or partial charges and contain bonds between atoms with very different electronegativities such as oxygen and hydrogen. Protic solvents have O—H or N—H bonds. Such bonds allow for participation in hydrogen bonding. Additionally, these O—H or N—H bonds can serve as a source of protons (H+). Aprotic solvents may have hydrogens on them somewhere, but they lack O—H or N—H bonds, and therefore cannot hydrogen bond with themselves. Polar solvents include, but is not limited to, dichloromethane, tetrahydrofuran, ethyl acetate, acetone, N,N-dimethylformamide, acetonitrile, dimethylsulfoxide, ammonia, butanol, propanol, ethanol, methanol, acetic acid and water. Included within this definition are also solvent mixtures, wherein the major component of the solvent mixture is a polar solvent. For example, water based solvent or solvent systems can also include dissolved ions, salts and molecules such as amino acids, proteins, sugars and phospholipids. Such salts may be, but not limited to, sodium chloride, potassium chloride, ammonium acetate, magnesium acetate, magnesium chloride, magnesium sulfate, potassium acetate, potassium chloride, sodium acetate, sodium citrate, zinc chloride, HEPES sodium, calcium chloride, ferric nitrate, sodium bicarbonate, potassium phosphate and sodium phosphate. As such, biological fluids, physiological solutions and culture medium also falls within this definition.

In some embodiments, the composition comprises a compound of Formula (I) or sub-Formulae (Ia) and a polar medium. For example, when the MIC value is 256 μM, in other embodiments, the composition comprises a compound of Formula (I) or sub-Formulae (Ia) and a polar medium, wherein the final concentration of the compound of Formula (I) or sub-Formulae (Ia) is about 130 μM. In other embodiments, the concentration is about 10 μM, about 20 μM, about 30 μM, about 40 μM, about 50 μM, about 100 μM, about 150 μM, about 200 μM, about 250 μM, about 300 μM, about 350 μM, or about 400 μM. In other embodiments, the concentration is not more than 10 μM, not more than 20 μM, not more than 30 μM, not more than 40 μM, not more than 50 μM, not more than 100 μM, not more than 150 μM, not more than 200 μM, not more than 250 μM, not more than 300 μM, not more than 350 μM, or not more than 400 μM.

Alternatively, the compounds can be provided as a kit. The kit can comprise the compound and the polar medium. The compound and the polar medium can be in separate vessels or as separately packaged components, to be mixed before use. Alternatively, the kit can comprise a composition of the compound in a first polar medium and separately a second medium, both components contained in separate vessels. The kit can additionally comprise another dye for staining a separate component of the bacterial cell. For example, the kit can additionally comprise FM 4-64. The kit can additionally comprise an excipient. The excipient can act to further stabilise the compound, and/or reduce the background noise by further quenching the fluorescence of the compound before its penetration into the bacterial cell membrane.

Compounds of the present disclosure are suitable for use as a dye or a fluorescence probe. The compounds may be used in membrane labelling, for viscosity sensing in membranes, for bioimaging and/or flow cytometry.

In particular, the compounds may preferentially stain certain domains of the cell membrane and/or lipid vesicles. These lipid domains may be characterised by a relative higher viscosity than the surrounding lipid regions. For example, the compounds may preferentially stain lipid rafts. Lipid rafts contain combinations of glycosphingolipids, cholesterol and protein receptors organised in glycolipoprotein lipid microdomains. It has been proposed that they are specialized membrane microdomains which compartmentalize cellular processes by serving as organising centers for the assembly of signaling molecules, allowing a closer interaction of protein receptors and their effectors to promote kinetically favorable interactions necessary for the signal transduction. Lipid rafts influence membrane fluidity and membrane protein trafficking, thereby regulating neurotransmission and receptor trafficking. Lipid rafts are more ordered and tightly packed than the surrounding bilayer, but float freely within the membrane bilayer. Being able to characterise and study lipid rafts in response to drugs may provide a better understanding of how cells respond to drugs.

It was found that the elongated backbone of COE compounds favor greater membrane stability, while the enriched hydrophilic groups are expected to increase aqueous solubility. Besides, these combined physical features increase both hydrophobic and electrostatic interactions to promote intercalation within the bilayer. When the compounds are used as membrane labelling dye, they may stably be incorporated within the lipid bilayers via the strong binding forces for a long-time staining.

The present disclosure also relates to a method of staining a cell membrane and/or lipid vesicle, comprising contacting the compound of Formula (I) or a salt or solvate thereof with the cell membrane and/or lipid vesicle.

The present disclosure also relates to a method of selectively staining a domain in a cell membrane and/or lipid vesicle, the domain having a higher viscosity relative to another region of the cell membrane and/or lipid vesicle, comprising contacting the compound of Formula (I) or a salt or solvate thereof with the cell membrane and/or lipid vesicle.

In some embodiments, the domain of the cell membrane and/or lipid vesicle is characterised by a presence of lipoprotein, glycosphingolipid and/or cholesterol.

In some embodiments, the domain of the cell membrane and/or lipid vesicle having a having a higher relative viscosity is characterised by a relatively higher density of lipoprotein and/or cholesterol.

In some embodiments, the cell membrane is from an adherent cell. Adherent cells are cells which must be attached to a surface to grow. They are commonly used in laboratory environments.

In some embodiments, the contact period is about 1 min to about 12 days. In some embodiments, the compound of Formula (I) or a salt or solvate thereof with the cell and/or lipid vesicle are incubated for about 5 min to about 120 min. In other embodiments, the duration is about 5 min to about 110 min, about 5 min to about 100 min, about 5 min to about 90 min, about 5 min to about 80 min, about 5 min to about 70 min, about 5 min to about 60 min, about 5 min to about 50 min, about 5 min to about 40 min, about 5 min to about 30 min, about 5 min to about 20 min, or about 5 min to about 10 min.

In some embodiments, the compound of Formula (I) is characterised by a fluorescence lifetime which is linearly correlated with a viscosity of the domain. For example, the linear correlation may be by a factor of about 0.2 to about 0.3.

In some embodiments, the compound of Formula (I) is characterised by a fluorescence emission lifetime of about 1.1 ns to about 1.8 ns at a viscosity of about 900 cP to about 1200 cP. In other embodiments, the fluorescence lifetime of about 1.1 ns to about 1.7 ns at a viscosity of about 1200 cP, or about 1.1 ns to about 1.6 ns, about 1.1 ns to about 1.5 ns, about 1.1 ns to about 1.4 ns, about 1.1 ns to about 1.3 ns, or about 1.2 ns to about 1.3 ns. In some embodiments, the compound of Formula (I) is characterised by a fluorescence emission lifetime of about 1.1 ns to about 3 ns at a viscosity of about 900 cP to about 1200 cP.

In some embodiments, the compound of Formula (I) is characterised by a bandgap of about 2.4 eV to about 2.7 eV.

In some embodiments, the compound of Formula (I) is characterised by a fluorescence intensity increase of about 20 times to about 50 times when inserted into a lipid bilayer.

In some embodiments, the compound of Formula (I) is characterised by a partition coefficient (Kp) between an aqueous medium and a lipid bilayer of about 4×10⁶ to about 7×10⁶ at 25° C.

In some embodiments, the compound of Formula (I) is characterised by a two photon absorption cross section area of about 150 GM to about 500 GM.

In some embodiments, the compound of Formula (I) is characterised by a IC50 of more than 50 μM.

The compounds may be used in flow cytometry to study biological cells, bacterial cells and extracellular vesicles (e.g., lipid vesicles, exosomes). These biological samples are defined by the essentiality of a lipid bilayer (membrane), of which COEs are designed to maintain a high affinity with. Hence, the physicochemical and optoelectronic properties of the compounds of the present disclosure when associated within a lipid bilayer allows them to be used a dye for flow cytometry applications or in flow systems.

The present disclosure also relates to a method of detecting a cell membrane and/or a lipid vesicle using a fluorescence detector, comprising:
a) contacting a compound of Formula (I) or a salt or solvate thereof with the cell membrane and/or lipid vesicle; and
b) passing the cell membrane and/or lipid vesicle through the fluorescence detector.

The present disclosure also relates to a method of tracking endocytosis in a cell, comprising:
a) contacting a compound of Formula (I) or a salt or solvate thereof with the cell; and
b) passing the cell through a fluorescence detector.

In some embodiments, the method is a method of tracking lipid vesicles in the cell and/or endosomes.

In some embodiments, the compound of Formula (I) is configured to exhibit an increasing fluorescence emission lifetime as it is internalised into the cell. In some embodiments, the compound of Formula (I) is characterised by a fluorescence emission lifetime of about 1 ns to about 1.5 ns about 0.5 h after uptake by the cell. In some embodiments, the compound of Formula (I) is characterised by a fluorescence emission lifetime of about 1 ns to about 1.5 ns when bound to a cell membrane of the cell.

In some embodiments, the compound of Formula (I) is characterised by a fluorescence emission lifetime of about 2 ns to about 2.5 ns about 1 h to about 2 h after uptake by the cell. In some embodiments, the compound of Formula (I) is characterised by a fluorescence emission lifetime of about 2 ns to about 2.5 ns when bound to an early endosome of the cell.

In some embodiments, the compound of Formula (I) is characterised by a fluorescence emission lifetime of about 2.7 ns to about 3 ns about 8 h to about 24 h after uptake by the cell. In some embodiments, the compound of Formula (I) is characterised by a fluorescence emission lifetime of about 2.7 ns to about 3 ns when bound to a late endosome of the cell.

[symbol]

The application of these compounds can be used in the staining of bacterial cells, mammalian (including but not limited to A549 cancer cells and red blood cells), and exosomes (especially unbound exosomes).

The cell can be a mammalian cell or a bacterial cell. In some embodiments, the bacterial cell is a Gram-positive or Gram-negative bacterial cell. In other embodiments, the Gram-negative or Gram-positive bacterial cells is selected from the group consisting of E. coli, P. aeruginosa, S. aureus, E. faecalis, S. oneidensis, B. megaterium or a combination thereof. The mammalian cell can be from a cell line, or from a sample derived from a subject.

In some embodiments, the sample of bacterial cells is a sample of planktonic bacterial cells.

‘Planktonic bacterial cells’ as used herein refers to free flowing bacterial cells in suspension. This is as opposed to the sessile state (or biofilm), in which a structured community of bacterial cells is enclosed in a self-produced polymeric matrix and adherent to an inert or living surface. In this regard, planktonic bacteria are free-living bacteria and makes up the populations that grow in test tubes and flask cultures in the laboratory.

The lipid vesicle is a structure within or outside a cell, consisting of a liquid or cytoplasm enclosed by a lipid bilayer. Vesicles form naturally during the processes of secretion (exocytosis), uptake (endocytosis) and transport of materials within the plasma membrane. Alternatively, they may be prepared artificially, in which case they are called liposomes. Unilamellar lipid vesicles has one phospholipid bilayer, while multilamellar lipid vesicles has more than one bilayer. Vesicles can also fuse with other organelles within the cell. A vesicle released from the cell is an extracellular vesicle. For example, the lipid vesicle can be an exosome. Exosomes are membrane-bound extracellular vesicles that are produced in the endosomal compartment of most eukaryotic cells. These lipid vesicles are included within the scope.

In some embodiments, the lipid vesicle is an extracellular vesicle. In other embodiments, the lipid vesicle is an exosome.

In some embodiments, the compound of Formula (I) or a salt or solvate thereof is provided at a concentration of about 1 nM to about 100 μM. In other embodiments, the concentration is about 1 nM to about 90 μM, about 1 nM to about 80 μM, about 1 nM to about 70 μM, about 1 nM to about 60 μM, about 1 nM to about 50 μM, about 1 nM to about 40 μM, about 1 nM to about 30 μM, about 1 nM to about 20 μM, about 1 nM to about 10 μM, about 1 nM to about 5 μM, about 1 nM to about 1 μM, about 1 nM to about 900 nM, about 1 nM to about 800 nM, about 1 nM to about 700 nM, about 1 nM to about 600 nM, about 1 nM to about 500 nM, about 1 nM to about 400 nM, about 1 nM to about 300 nM, about 1 nM to about 200 nM, about 1 nM to about 100 nM, about 1 nM to about 50 nM, or about 1 nM to about 20 nM.

In some embodiments, the compound of Formula (I) or a salt or solvate thereof with the cell membrane and/or lipid vesicle are incubated at about 5° C. to about 50° C. In other embodiments, the temperature is about 5° C. to about 45° C., about 5° C. to about 40° C., about 5° C. to about 35° C., about 10° C. to about 35° C., about 15° C. to about 35° C., or about 15° C. to about 30° C. In other embodiments, the temperature is room temperature or ambient temperature.

The compound of Formula (I) or a salt or solvate thereof and the cell and/or lipid vesicle can be incubated in an aqueous medium.

The term ‘aqueous medium’ used herein refers to a water based solvent or solvent system, and which comprises of mainly water. Such solvents can be either polar or non-polar, and/or either protic or aprotic. Solvent systems refer to combinations of solvents which resulting in a final single phase. Both ‘solvents’ and ‘solvent systems’ can include, and is not limited to, pentane, cyclopentane, hexane, cyclohexane, benzene, toluene, dioxane, chloroform, diethylether, dichloromethane, tetrahydrofuran, ethyl acetate, acetone, dimethylformamide, acetonitrile, dimethyl sulfoxide, nitromethane, propylene carbonate, formic acid, butanol, isopropanol, propanol, ethanol, methanol, acetic acid, ethylene glycol, diethylene glycol or water. Water based solvent or solvent systems can also include dissolved ions, salts and molecules such as amino acids, proteins, sugars and phospholipids. Such salts may be, but not limited to, sodium chloride, potassium chloride, ammonium acetate, magnesium acetate, magnesium chloride, magnesium sulfate, potassium acetate, potassium chloride, sodium acetate, sodium citrate, zinc chloride, HEPES sodium, calcium chloride, ferric nitrate, sodium bicarbonate, potassium phosphate and sodium phosphate. As such, biological fluids, physiological solutions and culture medium also falls within this definition.

As the compound of Formula (I) or a salt or solvate thereof emits fluorescence when intercalated with the cell membrane or lipid bilayer, fluorescence based techniques can be used to detect cells and/or lipid vesicles incorporated with compound of Formula (I) or a salt or solvate thereof. Examples of fluorescence based techniques include, but is not limited to, fluorescence microscopy, confocal microscopy, plate readers, fluorometer, fluorescence spectroscopy, and flow cytometry (such as fluorescence activated cell sorting).

The cell and/or lipid vesicle when incorporated with compound of Formula (I) or a salt or solvate thereof can be excited by an electromagnetic radiation (source) in a wavelength range of about 300 nm to about 1000 nm.

The cells can be adherent cells, or can be in suspension. The lipid vesicles can be exosomes (membrane-bound extracellular vesicles that are produced in the endosomal compartment of eukaryotic cells), synthetic and non-synthetic liposomes, or lipid nanoparticles (spherical vesicles made of ionizable lipids, which are positively charged at low pH and neutral at physiological pH). Advantageously, it was found that after intercalation of cell membranes by the fluorescence probe, the fluorescence probe can perpetuate to later cell populations.

In some embodiments, the cell and/or lipid vesicle can be flowed through a flow system without a purification step. This is possible as the free compound of Formula (I) or a salt or solvate thereof are weakly emissive and will yield less background.

By flowing the cell and/or lipid vesicle through the flow system, the cell and/or lipid vesicle can be excited by an electromagnetic radiation and subsequently detected by a detector. Accordingly, the method may further include a step of exposing the cell and/or lipid vesicle to electromagnetic radiation having a wavelength of less than about 2500 nm, or less than about 1000 nm.

In some embodiments, when the compound of Formula (I) or a salt or solvate thereof is inserted into the cellular and/or lipid membrane, the compound of Formula (I) or a salt or solvate thereof has an emission intensity of more than about 2 times to about 500 times relative to a control sample of the compound of Formula (I) or a salt or solvate thereof. In other embodiments, the emission intensity is more than about 10 times to about 500 times, about 20 times to about 500 times, about 30 times to about 500 times, about 40 times to about 500 times, about 50 times to about 500 times, about 60 times to about 500 times, about 70 times to about 500 times, about 80 times to about 500 times, about 90 times to about 500 times, about 100 times to about 500 times, about 100 times to about 450 times, about 150 times to about 450 times, about 200 times to about 450 times, about 250 times to about 450 times, about 300 times to about 450 times, or about 350 times to about 450 times.

A control in an experiment is a group separated from the rest of the experiment, where the independent variable being tested cannot influence the results. When testing a sample of cells and/or lipid vesicles, the at least one control sample may comprise a compound of Formula (I) or a salt or solvate thereof in an aqueous/water medium. In this regard, the control sample does not contain cells and/or lipid vesicles.

Advantageously, compounds of Formula (I) or a salt or solvate thereof have a low (or negligible) photoluminescence when dissolved in an aqueous medium. However, when partitioned into the lipid bilayer, the photoluminescence of compound of Formula (I) or a salt or solvate thereof is enhanced. It is believed that the change in local environment to a hydrophobic one (alkyl chains of the lipid bilayer) allows for the enhancement of fluorescence. Fluorescence is the emission of light by a substance that has absorbed light or other electromagnetic radiation. In general, the emitted light is of a longer wavelength than the absorbed light.

Because compound of Formula (I) or a salt or solvate thereof are advantageously non-toxic (or have a low toxicity) and/or have stable to excitation, when under constant excitation, the photoluminescence intensity may be maintained for a period of time. In this regard, the photoluminescence intensity does not decrease for some time when the compounds are excited under the appropriate wavelength for imaging. This is believed to be due to the conjugation system, which allows for the dissipation and transfer of energy, thus preventing localised heating and degradation of the compound. In some embodiments, the photoluminescence intensity may be maintained for at least 20 min, at least 30 min, at least 40 min, at least 50 min, at least 60 min, at least 1.5 h, at least 2 h, at least 3 h, at least 4 h, at least 6 h, at least 10 h or at least 24 h.

Compounds of Formula (I) or a salt or solvate thereof can work in combination with other dyes, for example membrane dye. For example, a commercial available dye, FM4-64, can be added to recognize bacterial envelope type in-situ in the bacteria mixture. In this regard, a dual-dye system that can recognise polymicrobial samples is also disclosed. These methods are easy-to-use requiring only a simple application of a dye mixture with no fixation or other pre-treatment requirement, and compound of Formula (I) or a salt or solvate thereof is stable in aqueous solution and can be used to monitor the cells in a living system.

Accordingly, in an embodiment, the method further comprises a step of contacting the cell and/or lipid vesicle with another dye. The dye can be used to stain cell membranes, nucleus, DNA, RNA, or other organelles in the cell. The dye can be a fluorescence probe, such as FM4-64, FM 2-10, FM 1-43, Propidium Iodide, SYTO 82, SYTO 83, SYTO 84, SYTO 85, YOYO®-3 iodide, YO-PRO™-3 Iodide, BOBO™-3 Iodide, Ethidium Homodimer-1, Ethidium Homodimer-2, Ethidium monoazide, Acridine Orange, CellMask™ Plasma Membrane Stains or Di-4-ANEPPS.

The present disclosure also relates to a flow system for detecting and/or quantifying cells membrane and/or lipid vesicle, comprising:
a) a compound of Formula (I) or a salt or solvate thereof for labelling the cell membrane and/or lipid vesicle;
b) an inlet for introducing the labelled cell membrane and/or lipid vesicle into the flow system;
c) a detection means in fluid communication with the inlet for detecting a fluorescence emission from the labelled cell membrane and/or lipid vesicle; and
d) optionally a counter means for quantifying the labelled cell membrane and/or lipid vesicle.

The flow system can for example be a microfluidic chip.

In some embodiments, the flow system further comprises an incubation means. The incubation means allows the compound of Formula (I) or a salt or solvate thereof to intercalate with the cell membrane or within the lipid bilayer.

In some embodiments, the detection means is a fluorescence detector.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### Examples

### General Protocol for the Synthesis of Compound of Formula (I)

### Synthesis Route of (a) COE-BYPhMe

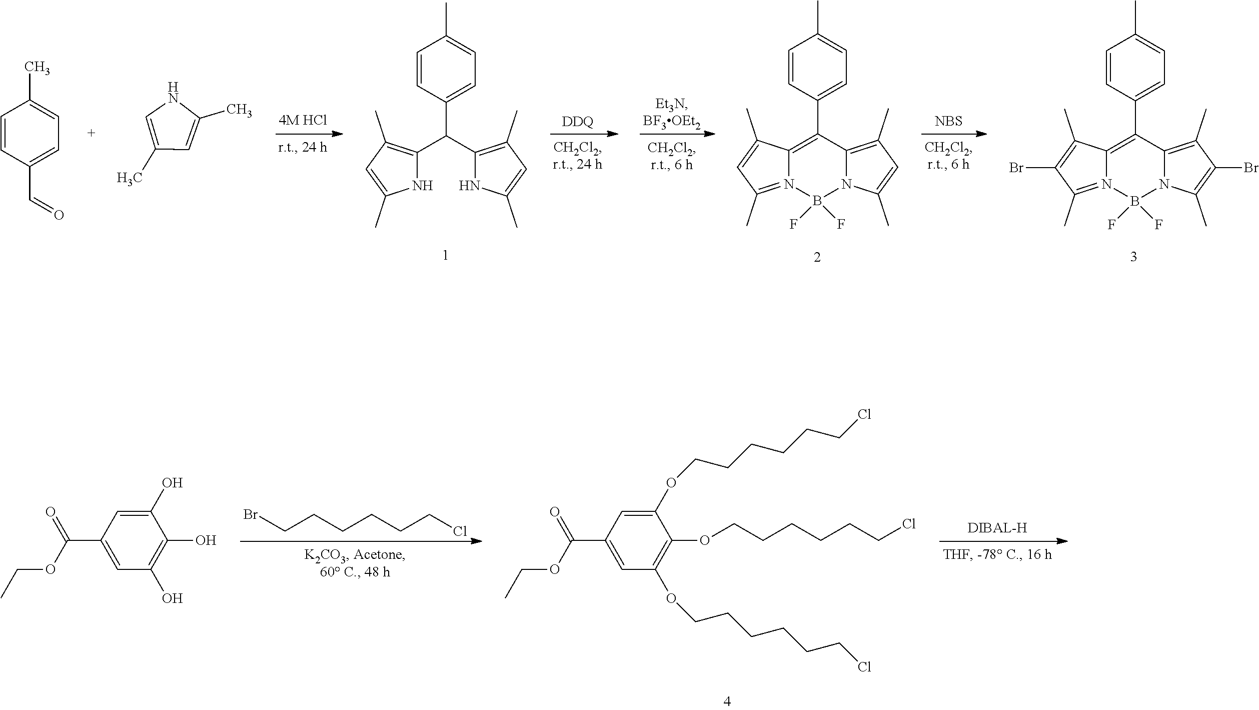

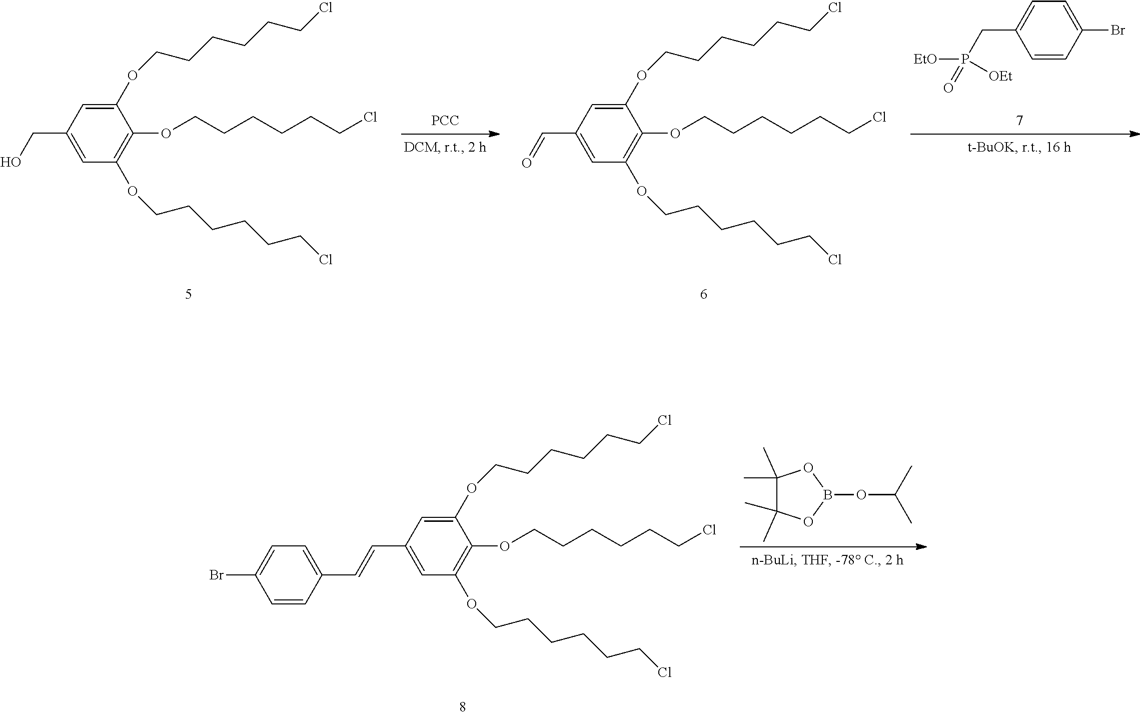

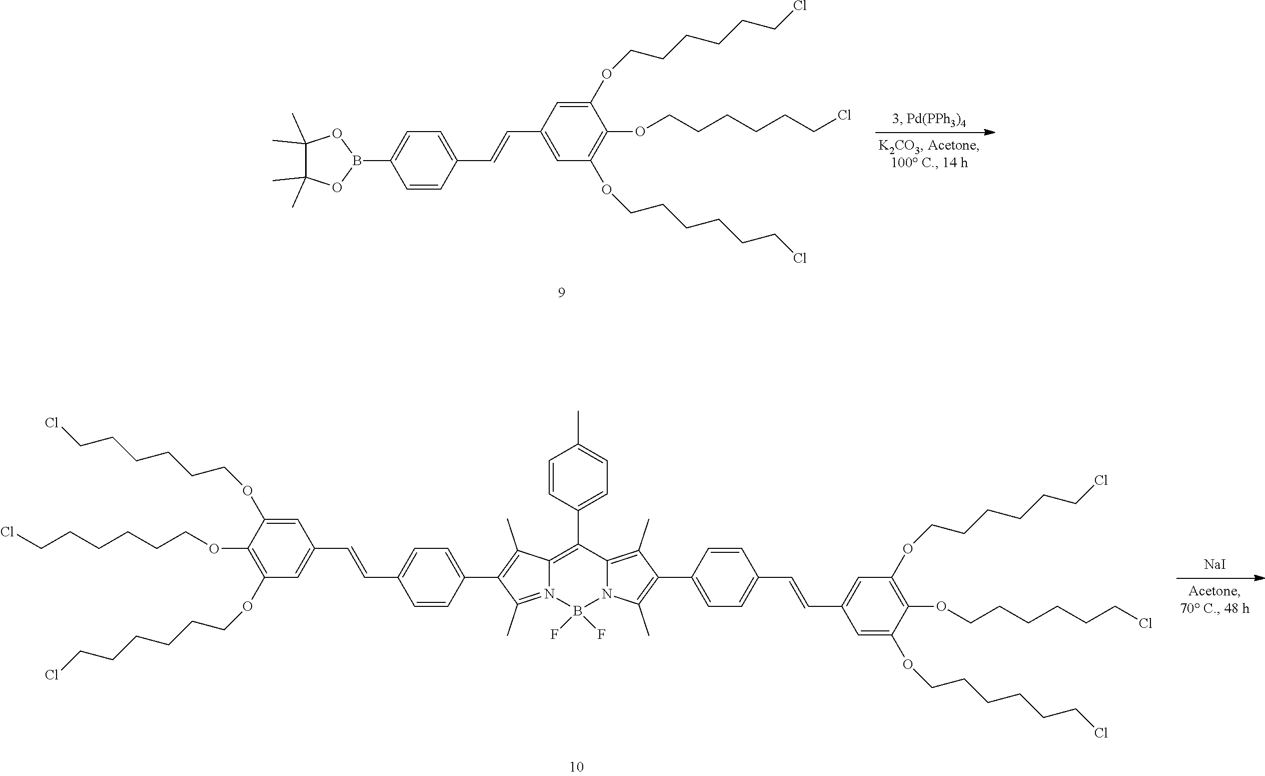

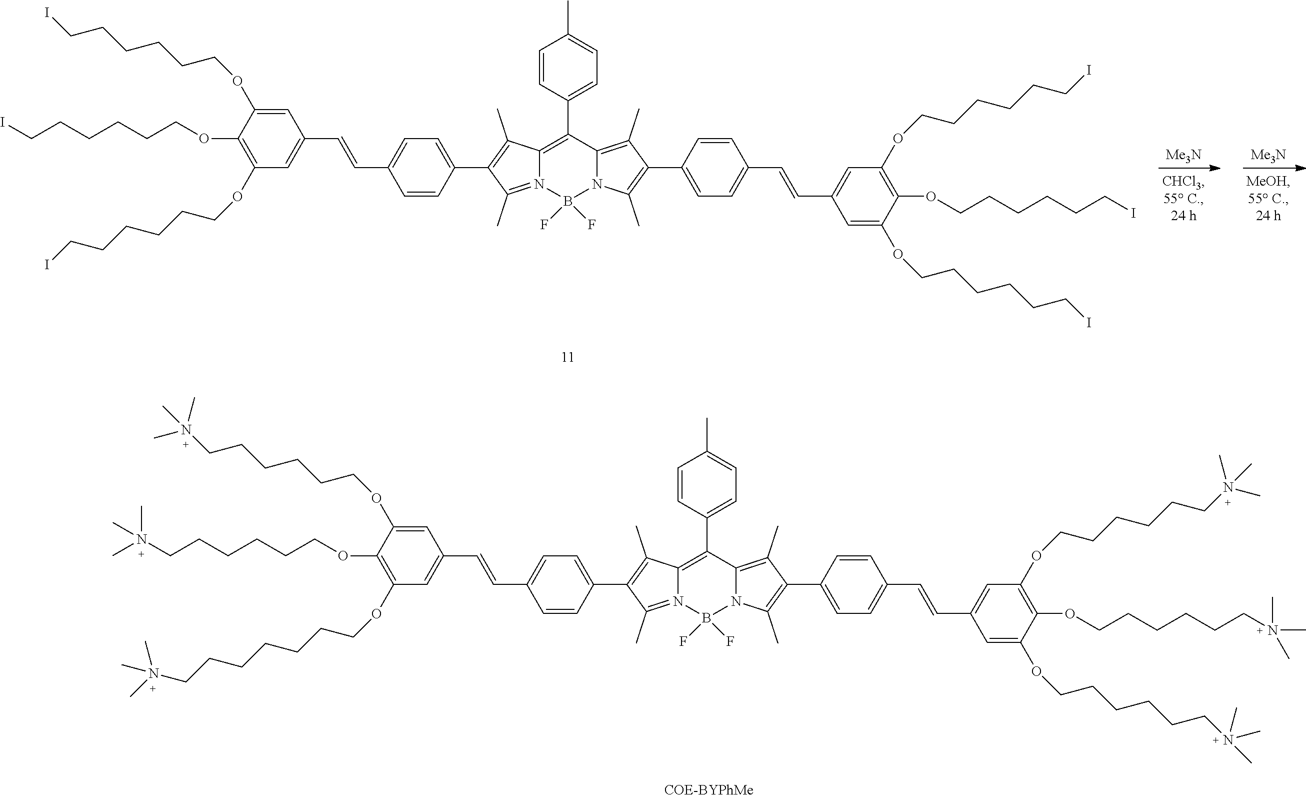

### (E)-4,4,5,5-tetramethyl-2-(4-(3,4,5-tris((6-chlorohexyl)oxy)styryl)phenyl)-1,3,2-dioxaborolane-(9)

In a 250 mL two-necked round-bottomed flask, compound 8 (2.5 g, 3.95 mmol) was dissolved in 50 mL anhydrous THF under a nitrogen atmosphere and cooled to −78° C. with stirring. n-Butyllithium (1 M in THF) (0.6 mL, 6 mmol) was added dropwise to the reaction mixture and stirred for 30 minutes. Subsequently, 2-isopropoxy-4,4,5,5-tetra methyl-1,3,2-dioxaborolane (2.2 g, 12 mmol) was added in 1 portion and the reaction mixture was slowly warmed to room temperature and stirred for 16 hours. The reaction mixture was quenched with water and extracted with DCM (200 mL). The organic phase was washed with water (2×100 mL), brine (1×100 mL), dried over Na₂SO₄, and concentrated under reduced pressure. The crude product was purified by column chromatography with silica (DCM/hexanes, 1:2), and the product as obtained as a colorless solid (1.5 g, 52% yield).

¹H NMR (300 MHz, Chloroform-d) δ 7.78 (s, 2H), 7.51 (s, 2H), 7.05 (s, 2H), 6.72 (s, 2H), 4.00 (d, J=18.2 Hz, 6H), 3.56 (s, 6H), 1.82 (s, 12H), 1.53 (s, 13H), 1.35 (s, 12H).

### 5,5-difluoro-1,3,7,9-tetramethyl-10-(p-tolyl)-2,8-bis(4-((E)-3,4,5-tris((6-chlorohexyl)oxy)styryl)phenyl)-5H-414,514-dipyrrolo[1,2-c:2′,1′-f][1,3,2]diazaborinine-(10)

In a 250 mL two-necked round-bottomed flask, compound 9 (500 mg, 0.7 mmol), compound 3 (165 mg, 0.3 mmol), K₂CO₃ (207.3 mg, 1.5 mmol) and Pd(PPh₃)₄ (2 mg, 4 mol %) were added and the flask was purged with nitrogen. 20 mL of toluene was added to dissolve the solids, and the reaction mixture was heated to 100° C. and stirred for 24 hours. After being cooled to room temperature, reaction mixture was poured into water and extracted with DCM (100 mL). The organic phase was washed with water (3×50 mL), brine (1×50 mL), dried over Na₂SO₄, and concentrated under reduced pressure. The crude product was purified by column chromatography with silica (DCM/hexanes, 4:1), and the product as obtained as a red solid (150 mg, 33% yield).

¹H NMR (400 MHz, Chloroform-d) δ 7.50 (s, 4H), 7.30 (s, 2H), 7.24 (s, 2H), 7.17 (s, 4H), 7.02 (s, 4H), 6.72 (s, 4H), 4.04 (s, 8H), 3.98 (s, 4H), 3.56 (s, 13H), 2.57 (s, 6H), 2.44 (s, 3H), 1.83 (s, 24H), 1.54 (s, 24H), 1.37 (s, 6H).

### 5,5-difluoro-1,3,7,9-tetramethyl-10-(p-tolyl)-2,8-bis(4-((E)-3,4,5-tris((6-iodohexyl)oxy)styryl)phenyl)-5H-414,514-dipyrrolo[1,2-c:2′,1′-f][1,3,2]diazaborinine-(11)

In a 250 mL two-necked round-bottomed flask, compound 10 (300 mg, 0.2 mmol) and sodium iodide (NaI) (0.6 g, 4 mmol) were dissolved in 100 mL of acetone. The reaction mixture was heated to reflux and stirred for 48 hours. After being cooled to room temperature, reaction mixture was poured into water and extracted with DCM (100 mL). The organic phase was washed with water (3×50 mL), brine (1×50 mL), dried over Na₂SO₄, and concentrated under reduced pressure. The crude product was purified by column chromatography with silica (DCM/hexanes, 4:1), and the product as obtained as a red solid (258 mg, 63% yield).

¹H NMR (400 MHz, Chloroform-d) δ 7.52 (s, 4H), 7.30 (s, 2H), 7.24 (s, 2H), 7.17 (s, 4H), 7.01 (s, 4H), 6.71 (s, 4H), 4.03 (s, 8H), 3.97 (s, 4H), 3.21 (s, 12H), 2.57 (s, 6H), 2.43 (s, 3H), 1.87 (s, 24H), 1.52 (s, 24H), 1.36 (s, 6H).

### COE-BYPhMe

In a round-bottomed flask compound 11 (100 mg) was dissolved in 20 mL of CHCl₃. A solution of trimethylamine (2 M in THF) was added to the reaction mixture and stirred at 55° C. for 24 hours. The solvents were removed under reduced pressure and the residue was redissolved in 20 mL of methanol. A solution of trimethylamine (3.2 M in MeOH) was added to the reaction mixture and stirred at 55° C. for 24 hours. The solvents were removed under reduced pressure and the residue was washed extensively with THF and CHCl₃ until the filtrate was colorless. The product was dried under vacuum and obtained as a dark red powder (80 mg).

¹H NMR (400 MHz, DMSO-d₆) δ 7.61 (s, 4H), 7.41 (s, 2H), 7.36 (s, 2H), 7.26 (s, 4H), 7.22 (s, 4H), 6.92 (s, 4H), 4.04 (s, 9H), 3.89 (s, 4H), 3.29 (s, 12H), 3.05 (s, 54H), 1.69 (s, 24H), 1.51 (s, 12H), 1.35 (s, 18H).

### Emission Enhancement Upon Membrane Intercalation

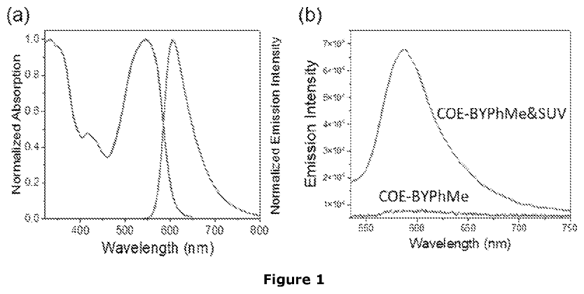

Liposomes were prepared using the following protocol. Phospholipids (ex. POPC, POPE, and POPG) in chloroform solution were mixed to a proper molar ratio and dried under a gentle stream of nitrogen. The dried lipids were further desiccated in a vacuum overnight to obtain a thin lipid film. For preparing small unilamellar vesicles (SUVs), rehydration of the dried film was carried out by adding phosphate buffered saline (PBS) to a concentration of 5 mg mL⁻¹, followed by incubation at 35° C. for 2 h under constant stirring at ≈300 rpm. Then, the vesicles were extruded using a 100 nm membrane at 45° C. 21 times to obtain SUV samples. Vesicles were kept at 4° C. until further use. The emission of COEs will enhance significantly after the COEs intercalate into the lipid bilayers. Hence, the free dyes in the aqueous phase will be weakly emissive and will yield less background, which is ideal for obtaining a high signal-to-noise ratio. As shown in FIG. 1, COE-BYPhMe (1 μM) in PBS exhibits weak emission (λexcitation=520 nm). When mixing the POPC SUVs (500 μM) with COE-BYPhMe, the COE will intercalate into the lipid bilayers. This is spontaneously driven by the electrostatic and hydrophobic interactions between the COEs and the lipids. As a result, a significant emission enhancement is observed.

### Viscosity Sensitivity

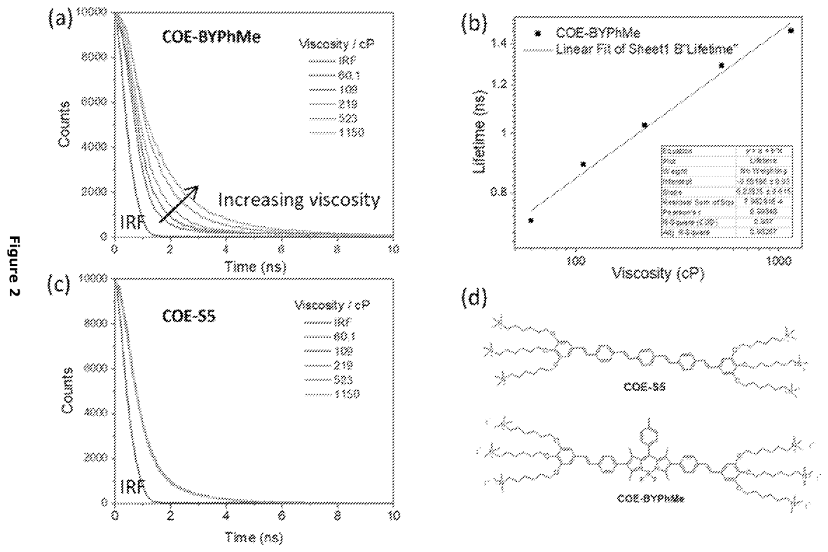

The BODIPY unit of COE-BYs are sensitive to the viscosity of its environment. As an example, COE-BYPhMe was added to mixtures of water and glycerol at various ratios. Emission spectra and fluorescent lifetimes are shown in FIG. 2. The viscosity of the local environment has the most significant effect on its emission intensity and emission lifetime. The plot of log τ (fluorescence lifetime) versus log η (solvent viscosity) is fitted by a straight line. No obvious lifetime differences were observed for COE-S5 in solutions of different viscosities (similar structure with COE-S5).

TABLE 1
Calculated fluorescence lifetimes of COE-BYPhMe
in water:glycerol mixtures of varying viscosities

| Viscosity | COE-BYPhMe |
|---|---|
| (cP) | Lifetime (ns) |
| 60.1 | 0.72 |
| 109 | 0.89 |
| 219 | 1.03 |
| 523 | 1.29 |
| 1150 | 1.47 |

### Analyte Viscosity Sensing

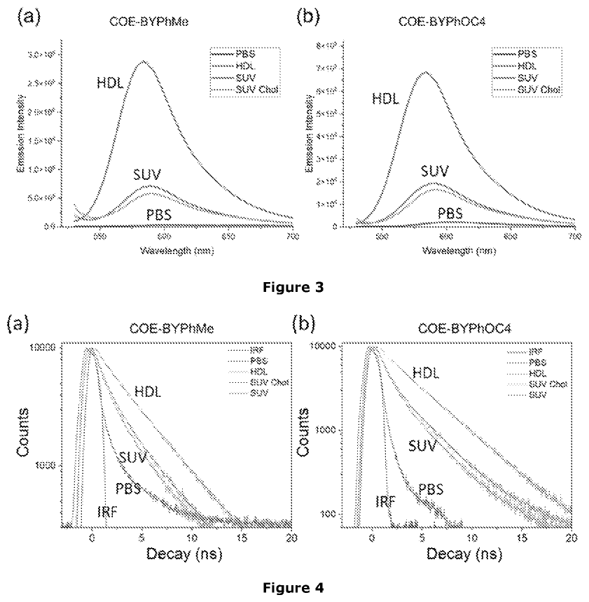

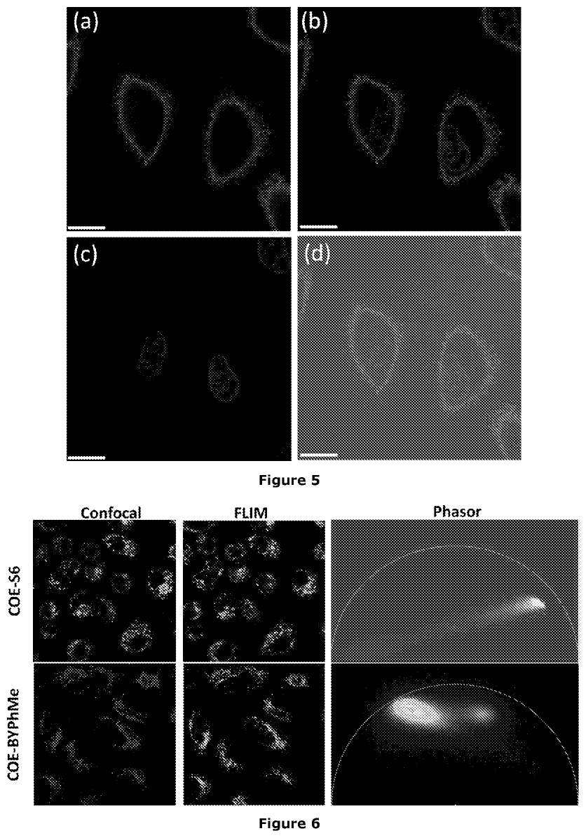

Solutions of bovine serum albumin (BSA), high density lipoprotein (HDL), Liposomes of POPC:POPG 85:15 (SUVs) and Liposomes of POPC:POPG:Cholesterol 42.5:7.5:50 (SUV CHOL) were prepared at final concentrations of 1 mg/mL in PBS. COE-BYs were prepared at 1 μM in PBS. 150 μL of analyte and 150 μL of COE-BYs were mixed and incubated for 1 hour at 37C. Fluorescent emission profiles were measured with excitation at 545 nm. Emission spectra shown in FIG. 3, and lifetime measurements in FIG. 4 demonstrate the sensitivity of COE-BYs to samples of different compositions.

TABLE 2
Fluorescence lifetimes of 0.5 μM COE-BYPhMe and
COE-BYPhOC4 in the presence of different analytes

| | COE-BYPhMe | COE-BYPhOC4 |
|---|---|---|
| Analyte | Lifetime(ns) | Lifetime(ns) |
| PBS | 0.66 ± 0.01 | 0.56 ± 0.01 |
| HDL | 3.88 ± 0.01 | 4.02 ± 0.01 |
| SUV | 2.16 ± 0.01 | 1.99 ± 0.01 |
| SUV CHOL | 2.37 ± 0.01 | 2.18 ± 0.01 |

### Confocal Microscopy and Fluorescent Lifetime Imaging (FLIM)

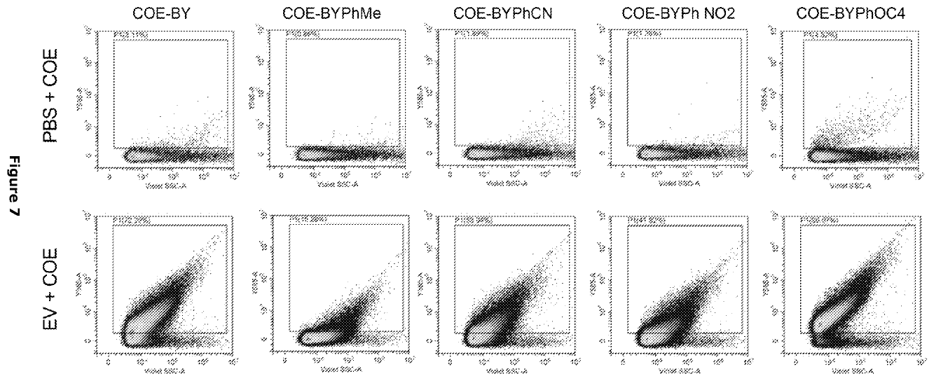

A549 cells were stained for 5 minutes with 0.75 μM COE-BYPhMe (red channel) before imaging and Hoechst 33342 (blue channel). Clear staining patterns delineating the cellular membrane were observed on the COE-BYPhMe channel shown in red (546/550 nm) (FIG. 5).

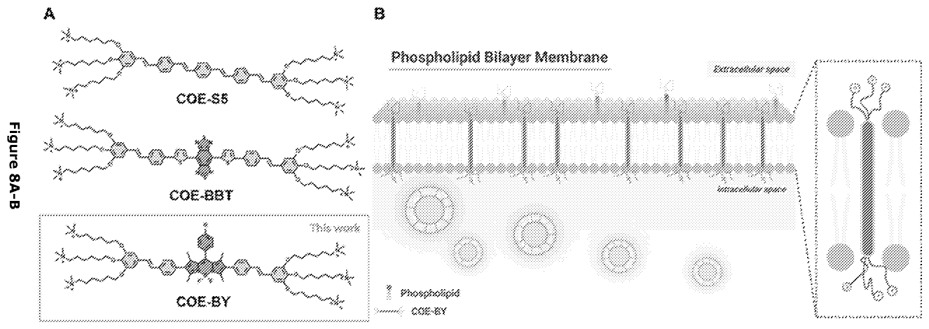

Fluorescence imaging is usually based on the analysis of fluorescence intensity, which is affected by many factors including dye concentration, laser power, the sensitivity of the detector, and sampling time. The main advantage of fluorescence lifetime imaging (FLIM) is independent of the above experimental conditions, especially the local dye concentration gradients, which makes FLIM an ideal method for studies in living cell models. The fluorescence lifetime of COE-BY series shows strong and fast responses to their environmental viscosity. The fluorescence lifetime of COE-BYs could be a function of viscosity after calibration. FLIM makes it possible to produce spatial viscosity maps after staining with COE-BYs. A549 cells were stained with COE-BYPhMe and COE-S6 (1 μM) for 24 hours, respectively. The cell samples were analyzed using two-photon fluorescence imaging and FLIM. In FIG. 6, we can observe that there are multiple lifetimes for COE-BYPhMe which is shown by the phasor plot. In contrast for the COE-S6 sample, there is only single area in the phasor plot which indicates more uniform lifetimes. The FLIM results demonstrate that COE-BY compounds are sensitive to their local environment within the cell, while COE-S6 is not. Given the previous COE-BY data showing the changes in lifetime due to viscosity of the environment and analytes, theses FLIM results indicate that the viscosity changes within the cell could be measured by COE-BYs.

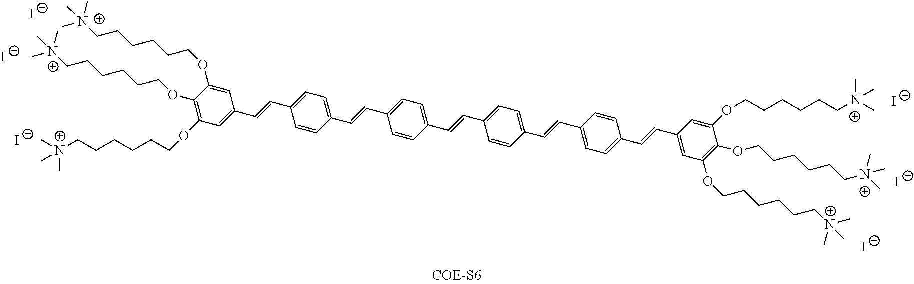

### Exosome Labelling and Detection by Flow Cytometry

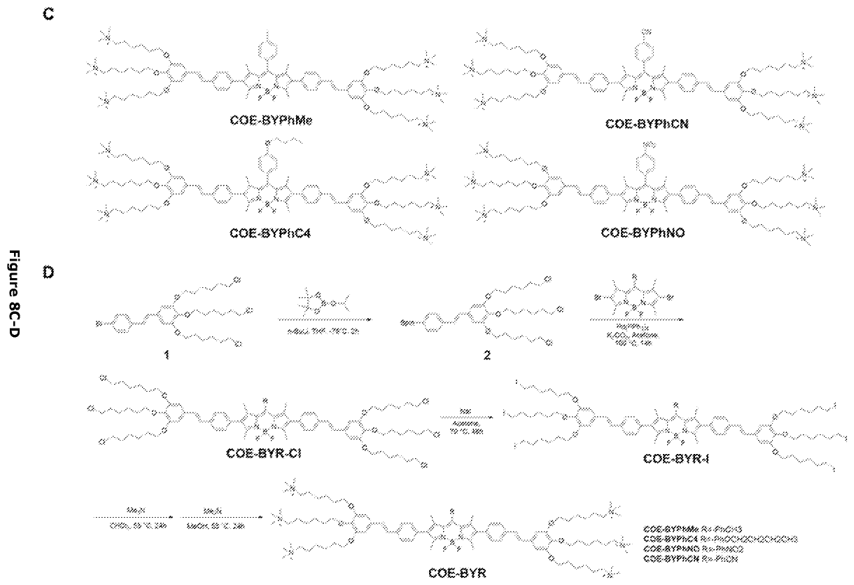

PC-3 Exosomes were purchased from Abcam, aliquoted and stored at −80° C. A single aliquot was removed from −80° C. and placed on ice. Exosomes were diluted 10 times in cell culture grade PBS to a final concentration of 20 ug/mL. 10 uL of the exosome suspension was mixed with 6 uM of COE-BY compounds. Samples were incubated at 37C for 1 hour before dilution 100× in PBS. Flow cytometry measurements were obtained by measuring the side scattering on the violet laser (x-axis) and by measuring fluorescent intensity (y-axis: excitation=561 nm emission=585 nm). The experiments in FIG. 7 demonstrates that exosomes can be successfully labelled and detected using COE-BY compounds.

### Molecular Design and Synthesis.

Four BODIPY-containing COEs were synthesized featuring identical stilbene outer wings and different internal BODIPY chromophores. Briefly, the di-bromo BODIPY derivatives and the conjugated wing 1 in FIG. 8D were synthesized as previously reported, with different benzaldehyde derivatives employed for the respective BODIPY building blocks. Compound 2 was obtained through lithiation-borylation of 1. The extended n-conjugated backbone was obtained via Suzuki-Miyaura cross-coupling reaction between the respective dibromo-BODIPY intermediates and 2 to yield the corresponding neutral precursors. Finkelstein halogen-exchange, followed by quaternization of COE-BYR-I with trimethylamine provided COE-BYPhMe, COE-BYPhOC4, COE-BYPhCN and COE-BYPhNO in greater than 90% yields. Structural characterization by multinuclear NMR spectroscopy and high-resolution mass spectrometry were performed to confirm that the compounds were correctly synthesized.

### Photophysical Properties.

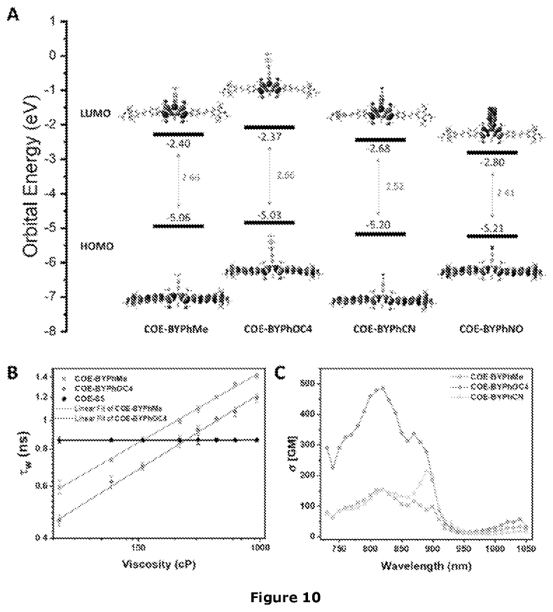

The photophysical properties of the COE-BY series were studied in phosphate-buffered saline (PBS) and within model lipid bilayers. Small unilamellar vesicles (SUVs) composed of 1-palmitoyl-2-oleoyl-glycero-3-phosphocholine (POPC) and 1-palmitoyl-2-oleoyl-sn-glycero-3-phospho-(1′-rac-glycerol) sodium (POPG) (85:15, mol/mol) were used to simulate the lipid environment in cell membranes. Key photophysical properties are summarized in FIG. 9 and Table 1. The absorption spectra in PBS for all compounds feature a main peak at ~550 nm, reflecting the presence of the BODIPY subunit (FIG. 9A). One also observes a 5-10 nm red-shift of lowest energy absorption peak with increasing electron-withdrawing strength of the phenyl substituents.

TABLE 1
Summary of relevant photophysical properties for
COE-BY series in PBS and SUV environments.

| | COE- | COE- | COE- | COE- |
|---|---|---|---|---|
| Compound | BYPhMe | BYPhOC4 | BYPhCN | BYPhNO |
| λ_{abs}[nm] | 545 | 540 | 550 | 556 |
| λₑₘ[nm]in PBS | 605 | 602 | 618 | 625 |
| λₑₘ[nm]in SUVs | 587 | 589 | 605 | 611 |
| FWHM [nm] | 52 | 56 | 63 | 68 |
| Φ_{F} [%] in PBS | 1 | 3 | 0.5 | — |
| Φ_{F} [%] in SUVs | 32 | 60 | 13 | 10 |

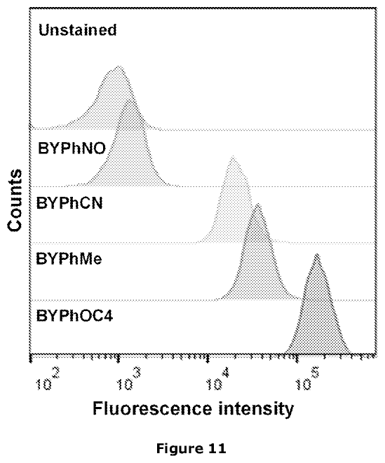

Density-functional theory (DFT) calculations were conducted to gain insights into the electronic states and molecular conformations. As shown in FIG. 10A, the highest occupied molecular orbital (HOMO) energies of COEs were calculated to be −5.06 eV (COE-BYPhMe), −5.03 eV (COE-BYPhOC4), −5.20 eV (COE-BYPhCN), and −5.21 eV (COE-BYPhNO). For the lowest unoccupied molecular orbital (LUMO) energies one finds −2.41 eV (COE-BYPhMe), −2.37 eV (COE-BYPhOC4), −2.68 eV (COE-BYPhCN), and −2.79 eV (COE-BYPhNO). Electron density is removed from the linear conjugated core in the HOMO to the central boron-containing heterocycle in the LUMO. Electron-withdrawing substituents (EWG, —NO₂/—CN) stabilize the LUMO, leading to a reduced bandgap from 2.66 eV for COE-BYPhMe and COE-BYPhOC4 to 2.52 eV for COE-BYPhCN and 2.41 eV for COE-BYPhNO and thus a red-shifted emission, as observed experimentally (FIG. 9B). Simulated absorption peaks, based on B3LYP/6-31G(d,p) method, matches the experimentally determined absorption spectra. The backbones of COE-BYs show a twisted conformation in the ground state.

Upon inserting into lipid bilayers, the fluorescence intensity increases over 27-fold for COE-BYPhMe, 30-fold for COE-BYPhOC4, 35-fold for COE-BYPhCN and 40-fold for COE-BYPhNO, relative to the values measured in PBS (FIG. 1c and FIG. S5). The increase in emission intensity reflects a transition to a more rigid and hydrophobic environment. Quantum yields increase to 32% for COE-BYPhMe, 60% for COE-BYPhOC4, 13% for COE-BYPhCN, and 10% for COE-BYPhNO in SUVs from 1% for COE-BYPhMe, 3% for COE-BYPhOC4, and 0.5% for COE-BYPhCN in PBS. The QY of COE-BYPhNO in PBS cannot be accurately determined by using a conventional fluorometer due to its weak fluorescence. The maximum emission wavelengths are redshifted from 587/589 nm (COE-BYPhMe/OC4) to 605/611 nm (COE-BYPhCN/NO) as a result of the decreased HOMO-LUMO energy gaps. As shown in FIG. 9E, one can observe with the naked eye differences in emission color as a function of chemical structure. Furthermore, the fluorescence spectra of COE-BYs intercalated within SUVs show a narrow band at wavelengths between 587 nm and 611 nm, with a full width half maximum (FWHM) linewidth of 52-68 nm (Table 1).

Giant unilamellar vesicles (GUVs) composed of 1-palmitoyl-2-oleoyl-glycero-3-phosphocholine (POPC) were chosen as the model membrane system for the initial studies because of their ideal size (diameter>1 μm) for imaging via optical microscopy. As shown in FIG. 9D, a strong uniform fluorescence from COE-BYPhOC4 can be observed throughout the entire GUV. When polarized light is applied to the same GUV, fluorescence is preferentially observed from polarized light orientation (from top to bottom), which indicates that the transition dipole moments of COE-BYs is perpendicular to the plane of the lipid bilayer. COE-BY series are thus embedded within the bilayer as membrane-spanning probes, a geometric consideration relevant to measuring membrane tension across the whole lipid bilayer, instead of a single leaflet.

To estimate membrane affinity, a solution of COE-BYPhOC4 was titrated with increasing concentration of SUVs. The resultant increase in fluorescence intensity was then fitted with a non-linear least squares regression method to calculate the partition coefficient (Kₚ) between the aqueous buffer and the lipid bilayer. The Kₚ of COE-BYPhOC4 was estimated to be (5.5±1.5)×10⁶ at 25° C., indicating strong preference for associating with POPC membranes (FIGS. 9D and 9E). Cryo-electron microscopy (cryo-EM) and dynamic lighting scattering (DLS) of SUVs treated with COE-BYs at 1 μM show no visible changes to the morphology of SUVs (FIG. 9H), suggesting that at these concentrations, COE-BYs do not perceivably modify membrane integrity.

### Viscosity Sensitivity in Solutions.

We examined the sensitivity of COE-BYs to changes in viscosity in solution by using different glycerol and water mixtures. The viscosities of the solutions were increased through increases of the glycerol fraction. Of interest was the relationship between the viscosity (η) and the amplitude-weighted average emission lifetime (τ_{w}), which is defined by

$${τ}_{w} = {\sum }_{i = 1}^{p} {A}_{i} {τ}_{i} / {\sum }_{i = 1}^{p} {A}_{i} .$$

Each individual lifetime component Tr is normalized to the corresponding amplitude (Aᵢ) derived from fitting the emission decay to a multiexponential model, where p is the total number of exponents (1 or 2). We chose τ_{w} as the reference observable, over single component lifetimes (τ₁ or τ₂), since single time constants are not necessarily directly associated with a single physical process. As shown in FIG. 10B, τ_{w} values measured for COE-BYPhMe and COE-BYPhOC4 at 590 nm and 20° C. increased gradually from 0.6 ns to 1.4 ns and 0.5 ns to 1.2 ns, respectively, as one increases the solution viscosity from 22.5 cP to 939 cP. It is known that increases in environmental viscosity restricts the rotation of the phenyl rings surrounding the BODIPY unit, which diminishes non-radiative decay pathways of the excited state, resulting in longer fluorescence lifetimes. As shown in FIG. 10B, there is a linear relationship (R²=0.9) between log(τ_{w}) and log (η), indicating that COE-BYs are suitable viscosity sensors. It is worth pointing out that the τ_{w} value of COE-S5 (see FIG. 8A) remains constant at 0.9 ns in different viscosity environments. Due to the low emission, we could not accurately extract emission lifetimes from the fluorescence decays of COE-BYPhCN and COE-BYPhNO. In addition, variations in pH showed no significant changes in τ_{w}, verifying that environmental viscosity is the key parameter influencing the lifetimes.

### Two-Photon Absorption of COE-BY Series.

Dynamic biological processes in live cells often take place at a rapid time scale, necessitating rapid image acquisition. For 2P-FLIM applications, this is especially relevant since a significant photon count is required to ensure accurate decay statistics and lifetime values. Two-photon imaging provides access to the NIR-II window for excitation (1000-1700 nm), minimizing photodamage and eliminating out of focus noise. As such, dye brightness plays a key role in enabling high-quality imaging. We thus evaluated their two-photon absorption cross-section of the COE-BY series. As shown in FIG. 10C, the COE-BY series features two photon absorption cross section areas of up to 486 GM for COE-BYPhOC4 (1 GM=10⁻⁵⁰ photon/cm⁴/s), when intercalated into SUVs which are competitive with other commercial dyes routinely employed in bioimaging such as Rhodamine B (150 GM) and carbocyanine DiL (10 GM). These properties will become relevant when determining the utility of COE-BYPhOC4 to image the endocytosis pathway and different response of living cells.

### Vesicle Internalization.

Biocompatibility was determined by measuring the cytotoxicity of the COE-BY series towards three mammalian cell lines. The half-maximal inhibitory concentration (IC₅₀) for all the COEs was above 50 μM, over 50-fold larger than the concentration used for labeling, indicating all the compounds are well-tolerated over extended periods of time.

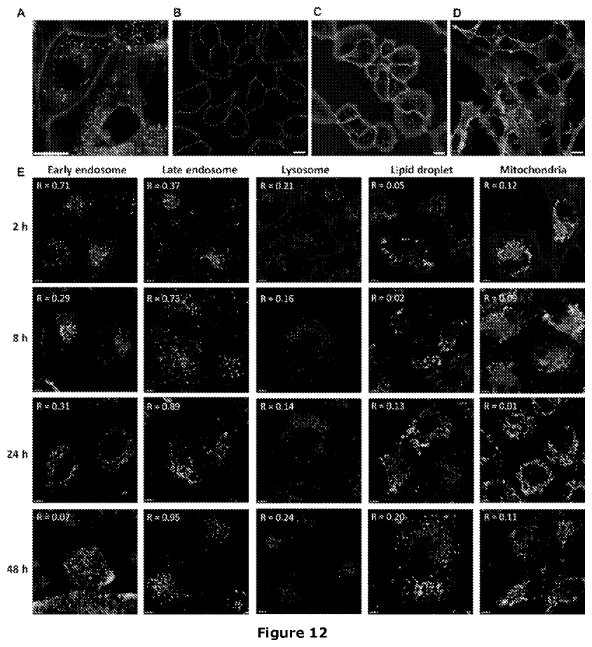

To evaluate their potential use as fluorescent probes for intracellular imaging, we first analyzed the brightness of each COE-BY molecule when used to stain HeLa cells using flow cytometry. As flow cytometry reports the fluorescence intensity per cell, this analysis would enable simultaneous evaluation of the cellular uptake and brightness. In line with the steady-state spectroscopic measurements, staining with BYPhOC4 resulted in cells with the highest brightness, followed by BYPhMe, BYPhCN, and BYPhNO (FIG. 11). Based on these parameters, COE-BYPhOC4 was chosen for further in vitro imaging studies.

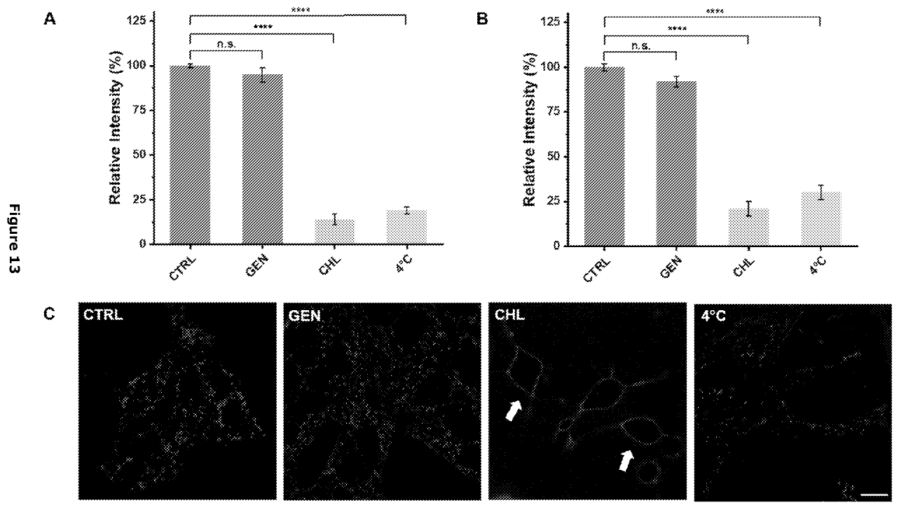

Our next objective was to study the cellular distribution of COE-BYPhOC4 series at different time points by conventional confocal microscopy. Consistent with experiments with model GUV systems (FIG. 9D), strong fluorescence signals were observed on the plasma membranes when MDCK and A549 cells were stained with COE-BYPhOC4 (FIG. 12A, 12B) for 10 minutes. Incubation for 4 hours showed predominantly intracellular emission, indicating that the majority of COE-BYPhOC4 was internalized. At this point, no dye was observed to reside on the membrane (FIG. 12C, 12D), thus enabling subcellular studies.

Insights into the intracellular location of COE-BYPhOC4 at different time points were sought through colocalization experiments with a panel of common commercial organelle probes (CellLight Early Endosome-GFP, CellLight Late Endosome-GFP, CellLight Lysosomes-GFP, LipidTOX™ Deep Red, and MitoTracker Deep Red). To label the vesicles in the endocytic pathway with high specificity and avoid dye translocation associated with alkalinizing effects and equilibrium shifts after extended durations, we elected to use GFP-tagged markers that are definitive for each vesicle subtype, namely Rab5a, Rab7a, and Lamp-1 for early endosomes, late endosomes, and lysosomes respectively. As shown in FIG. 12, after incubation for 2 h, the red fluorescence signals from COEs exhibited a Pearson's correlation coefficient value (R) of 0.71 relative to the green fluorescence of GFP-tagged Rab5a (early endosome), implying that a high proportion of COEs were internalized within early endosomes at this time point. Subsequently at 8 hours, the highest overlay can be observed from COEs and the late endosome marker. Prolonged incubation beyond this point further increased the degree of colocalization, from 0.73 at 8 hours to 0.95 at 48 h. That even after 48 hours, COE-BYPhOC4 remains co-localized with Rab7a and not Lamp-1 suggests that COE-BYPhOC4 remained within late endocytic organelles rather than degradative lysosomes. At the same time one observes poor colocalization with lipid droplets and mitochondria markers at all timepoints, highlighting the specificity of COE-BYPhOC4 for the endocytic pathway. There was also poor colocalization with lipid droplets and mitochondria markers at all timepoints, highlighting the specificity of COE-BYPhOC4 for the endocytic pathway.

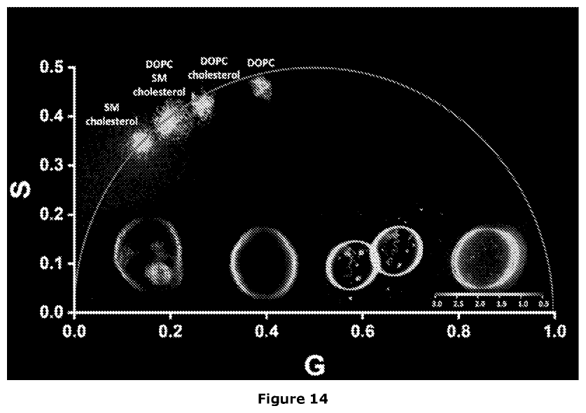

To further understand the internalization of COE-BYPhOC4, A549 and HeLa cells were pretreated with endocytic inhibitors including pharmacological treatments genistein (caveolae-dependent), chlorpromazine (clathrin-dependent) and low temperature (energy-dependent). Cells were then stained by treatment with 1 μM COE-BYPhOC4 and the endocytosis inhibition efficiency was characterized by flow cytometry and fluorescence confocal imaging. As shown in FIGS. 13A and 13B, after incubation with COE-BYPhOC4 for 3 h, chlorpromazine pretreatment resulted in only 14% dye fluorescence intensities in A549 cells and 21% in HeLa cells relative to the untreated group while the genistein pretreated group showed 95% (A549) and 92% (HeLa) intensities. Low temperature (4 degrees) decreased COE-BYPhOC4 uptake similarly to clathrin inhibition, indicating that COEs enter cells mainly through clathrin-mediated endocytosis. The confocal images in FIG. 13C provide additional confirmation of this endocytosis pathway. Fluorescence signals are only observed on the plasma membranes in the chlorpromazine pretreated group, while COE-BYPhOC4 readily underwent endocytosis and appeared as red vesicular puncta in the other three groups. Successful plasma membrane staining similar to FIG. 12A also provides evidence of insertion into the membrane prior to endocytosis and subsequent trafficking together with other lipid molecules, as opposed to being directly engulfed within intracellular vesicles. This feature enables the dye to follow the endosomal pathway throughout the maturation process beginning from the plasma membrane, as opposed to commonly employed pH-dependent methods to control accumulation within vesicle subtypes.

### Fluorescence Lifetime Imaging Microscopy (FLIM).

FLIM is a time-resolved method used to obtain information on the emission decay of a fluorophore in different cellular environments. Being independent of parameters such as local dye concentration, absorption profile, and excitation intensity, FLIM is sensitive to changes in the fluorophore itself relative to intensity-based measurements. Accordingly, we first used GUV model systems with a well-defined composition to measure the lifetime of the probe in environments of known lipid packing. Being independent of parameters such as local dye concentration, absorption profile, and excitation intensity, FLIM is sensitive to changes in the fluorophore itself relative to intensity-based measurements. Accordingly, we first used GUV model systems with a well-defined composition to measure the lifetime of the probe in environments of known lipid packing. For this purpose, use used compositions of, in order of increased membrane tension, DOPC, DOPC with cholesterol (Chol), sphyngomyelin (SM) and SM with Chol. This series of GUVs allows us to examine to what extent τ_{w} of intercalated COE-BYPhOC4 is responsive to different levels of membrane tension.

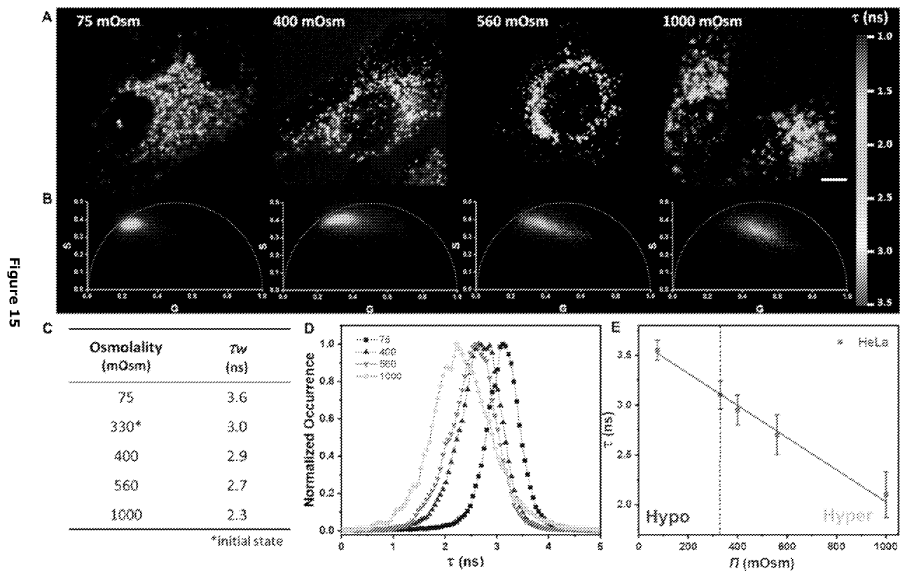

GUVs were thus first stained with 1 μM COE-BYPhOC4 and were imaged via conventional FLIM. Each pixel of an intensity image is mapped to a point in the phasor plot corresponding to τ_{w}. Mono-exponential lifetimes are located on the universal circle and multi-exponential ones toward the interior of the circle. In the plot, the short lifetimes are on the right while longer lifetimes are shifted to the left. We can observe in FIG. 14 that with increased higher membrane tension, τ_{w} increased from 1.6±0.2 ns in DOPC to 2.8±0.3 ns in SM/Chol vesicles. All the lifetimes measured are predominantly described by a mono-exponential fit. Overall, these findings are in agreement with the original hypothesis that the photophysical properties of COE-BY molecules can provide information on the physical states of the membranes.

### Response to Osmotic Shock.

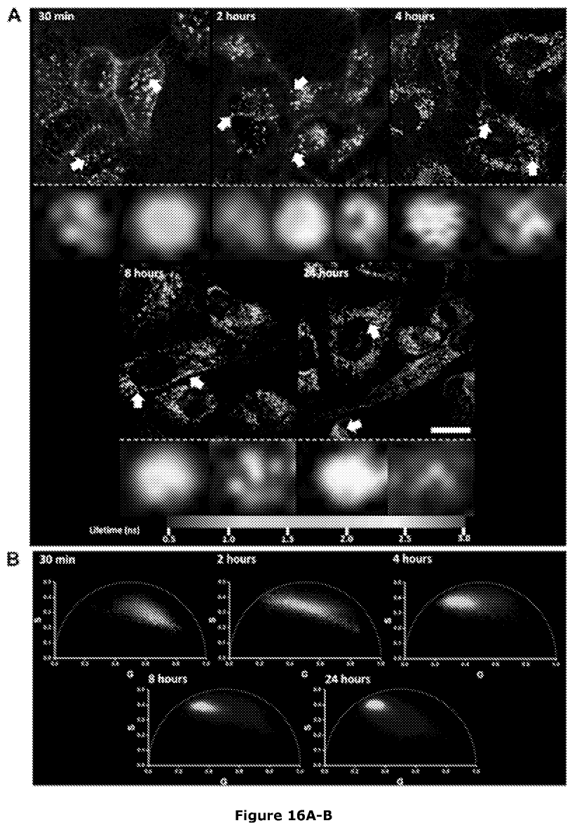

Changes in external osmotic pressure result in an adaptive cellular response with quantitative changes in membrane tension. We thus applied osmotic shock to gauge whether COE-BYPhOC4 is capable of reporting on membrane tension changes of vesicles within cells. HeLa cells were first stained with COE-BYPhOC4 for 6 hours, and the media was replaced with solutions of varying osmolarity (P), see Supporting Information. FIGS. 15A and 15B showcase the changes in τ_{w} through 2P-FLIM imaging taken after changing the media. AsP increases, causing a concomitant decrease in membrane tension, we observe a corresponding decrease in τ_{w}. At the same time, a decrease in P causes an increase in τ_{w}. The observed τ_{w} values as a function of P are summarized in FIG. 15C. Indeed, one finds a linear response between τ_{w} and P (FIG. 15C). Another interesting insight from the phasor plots in FIG. 155 is the wider distribution of vesicles with different membrane tensions with increasing P. This feature can be readily appreciated in the plot of occurrence vs τ_{w} in FIG. 15D. The photophysical properties COE-BYPhOC4 thus provide a response to changes in membrane properties induced by external perturbations.

It is worth pointing out that key to the environmental sensitivity of the COE-BY reporters is the more hindered rotation in the BODIPY fragment in more constrained or viscous environments, which ultimately leads to longer fluorescence lifetimes. Such a mechanism is different from that which determines the modulation of flipper probes, namely that mechanosensitivity arises from planarization of the molecule by a physical force. Flipper molecules also embed within a single leaflet, whereas COEs generally span the entire bilayer. Overall, the two classes of reporters provide the opportunity to obtain complementary information regarding physical properties of membranes in living cells as a function of different environmental stress conditions or via the action of pharmaceutical agents.

### Membrane Tension Imaging.

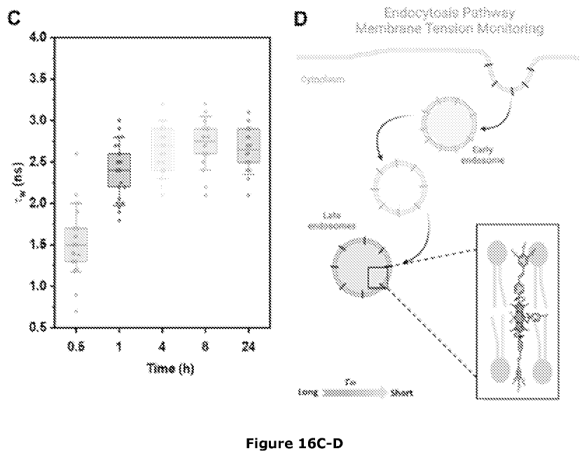

Having demonstrated the responsiveness to environmental perturbations by COE-BYPhOC4, we sought to investigate changes in membrane tension during the endocytosis process. We thus stained HeLa cells with COE-BYPhOC4 for different lengths of time and captured 2P-FLIM images of the cell state at specific intervals. For these studies, we correlated the time-dependent colocalization experiments with 2P-FLIM data to link τ_{w} with the identity of the vesicles. As shown in FIG. 16A, at 0.5 h, blue signals (τ_{w}≈1.5 ns) are observed on plasma membranes, together with regions that were beginning to be internalized reflected as deep blue points (τ_{w}≈1.0 ns), suggesting the membrane tension was lower as the regions become more fluid. Inside cells, vesicles close to the plasma membrane, likely having just dissociated, displayed the same τ_{w} as that of the dye in the plasma membrane. Vesicles that were taken up earlier displayed an increased fluorescence lifetime in green color (τ_{w}≈2.0-2.4 ns), reflecting the change of vesicle characteristic. Time dependent colocalization with Rab5a allowed us a means of assigning the identities of the vesicles. At 2 hours, the blue and green vesicles in FLIM image were identified as early endosomes. Upon increasing staining time to 4 h, all COE-BYPhOC4 entered the cells with a further increase in τ_{w}, leading to a main yellow color. Further incubation from 8 to 24 h showed a marginal increase in the lifetimes, featuring only red-orange vesicles (τ_{w}≈2.7-3.0 ns). As previously analyzed from the colocalization images in FIG. 12, all the COEs resided exclusively within late endosomes at this point in time. Interestingly, the heterogeneity within vesicles could also be observed through 2P-FLIM, with each vesicle featuring both regions of low and high tension. This observation is potentially reflective of the different domains in endosomes.

The lifetime of the particles in FIG. 16A was also analyzed with phasor plots to categorize the vesicle environments of COE-BYPhOC4 during endocytosis, see FIG. 16B. At 0.5 h, we can observe a broad distribution of lifetimes, which gradually shifts towards to the left of the plot and becomes narrower, merging into a tight population near the universal circle at 24 h. These changes imply a gradual increase in membrane tension as the vesicle matures. FIG. 16C summarizes the changes in τ_{w} as a function of time and highlights a monotonic increase in membrane tension along the endocytic pathway. Previous studies of endosomal composition have shown an increase in rigid or raft-like domains as the vesicles mature from early to late endosomes in the non-degradative pathway. Using COE-BYPhOC4, we show here that these changes in physical parameters of the vesicles are captured as changes in τ_{w}. (FIG. 16D) as the vesicles mature from early to late endosomes in the non-degradative pathway.

### CONCLUSION

In summary, we designed and synthesized a new type of COE that is responsive to the mechanoproperties of membranes. Specifically, the COE-BY series with BODIPY molecular rotors show high affinity for lipid bilayers and are sensitive to local membrane tension. These molecules exhibit high brightness and two-photon cross section area, enabling NIR-II excitation with two-photon microscopy. In addition, the changes in fluorescence lifetime of the molecule closely reflected both solution viscosity and the membrane tension of the lipid bilayer. The brightest molecule COE-BYPhOC4 was used to visualize the live-cell membrane tension of the endosomal system. The response of the fluorescence lifetime of COE-BYPhOC4 to rapid changes in osmotic pressure verified its applicability as a membrane tension sensitive probe. Long-term monitoring of live cells incubated with the dye over a period of 24 hours with 2P-FLIM, demonstrating the relative increase in membrane tension as the vesicle matures over the course of time.

1. A compound of Formula (I) or a salt or solvate thereof: 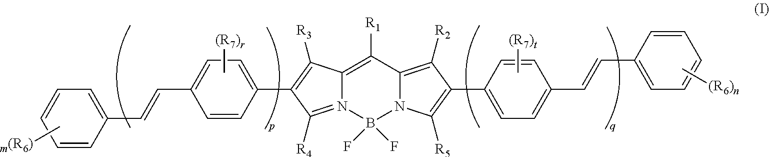
wherein
R₁ is selected from optionally substituted alkyl, optionally substituted aryl, or optionally substituted heteroaryl;
R₂, R₃, R₄, R₅ are each independently selected from H or optionally substituted alkyl;
each R₆ is independently selected from halogen, optionally substituted alkyl, optionally substituted alkenyl, optionally substituted alkynyl, optionally substituted alkoxy, optionally substituted alkenyloxy, optionally substituted alkynyloxy, optionally substituted acyl, optionally substituted oxyacyl, optionally substituted acyloxy, optionally substituted amino, optionally substituted aminoacyl, optionally substituted acylamino, optionally substituted aminoacyloxy, optionally substituted oxyacylamino, optionally substituted oxyacyloxy or optionally substituted thio or optionally substituted phosphoryl;
each R₇ is independently selected from halogen, cyano, optionally substituted alkyl, optionally substituted alkenyl or optionally substituted alkynyl;
m and n are independently an integer selected from 1 to 5;
p and q are independently an integer selected from 1 to 3; and
r and t are independently an integer selected from 0 to 4.

2. The compound according to claim 1, wherein R₁ is optionally substituted aryl.

3. The compound according to claim 1, wherein the optional substituent on R₁ is selected from alkyl, alkoxy, amino, cyano, or nitro.

4. The compound according to claim 1, wherein R₂, R₃, R₄, R₅ are each optionally substituted alkyl.

5. The compound according to claim 1, wherein R₂, R₃, R₄, R₅ are each independently selected from methyl, ethyl, propyl, t-butyl or n-butyl.

6. The compound according to claim 1, wherein each R₆ is independently selected from optionally substituted alkyl, or optionally substituted alkoxy.

7. The compound according to claim 1, wherein each R₆ is independently selected from alkyl and alkoxy, each optionally substituted with amino, or alkylamino.

8. The compound according to claim 1, wherein each R₆ is independently C₃-C₈ alkoxy substituted with amino, or alkylamino.

9. The compound according to claim 1, wherein n is 3 and m is 3.

10. The compound according to claim 1, wherein R₆ is at a meta and/or para position relative to the ethylene moiety.

11. The compound according to claim 1, wherein the compound of Formula (I) is a compound of Formula (Ia): 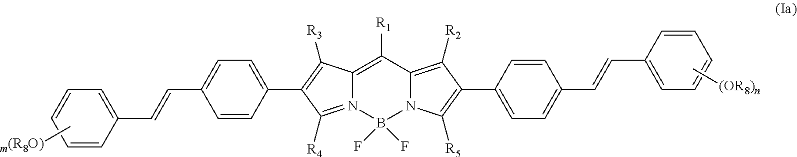
wherein
R₁ is selected from optionally substituted alkyl, optionally substituted aryl, or optionally substituted heteroaryl;
R₂, R₃, R₄, R₅ are each independently selected from H or optionally substituted alkyl;
each R₈ is independently optionally substituted alkyl;
n is an integer selected from 1 to 5; and
m is an integer selected from 1 to 5.

12. The compound according to claim 11, wherein each R₈ is independently C₄-C₈ alkyl optionally substituted with amino.

13. The compound according to claim 1, wherein the compound of Formula (I) is selected from

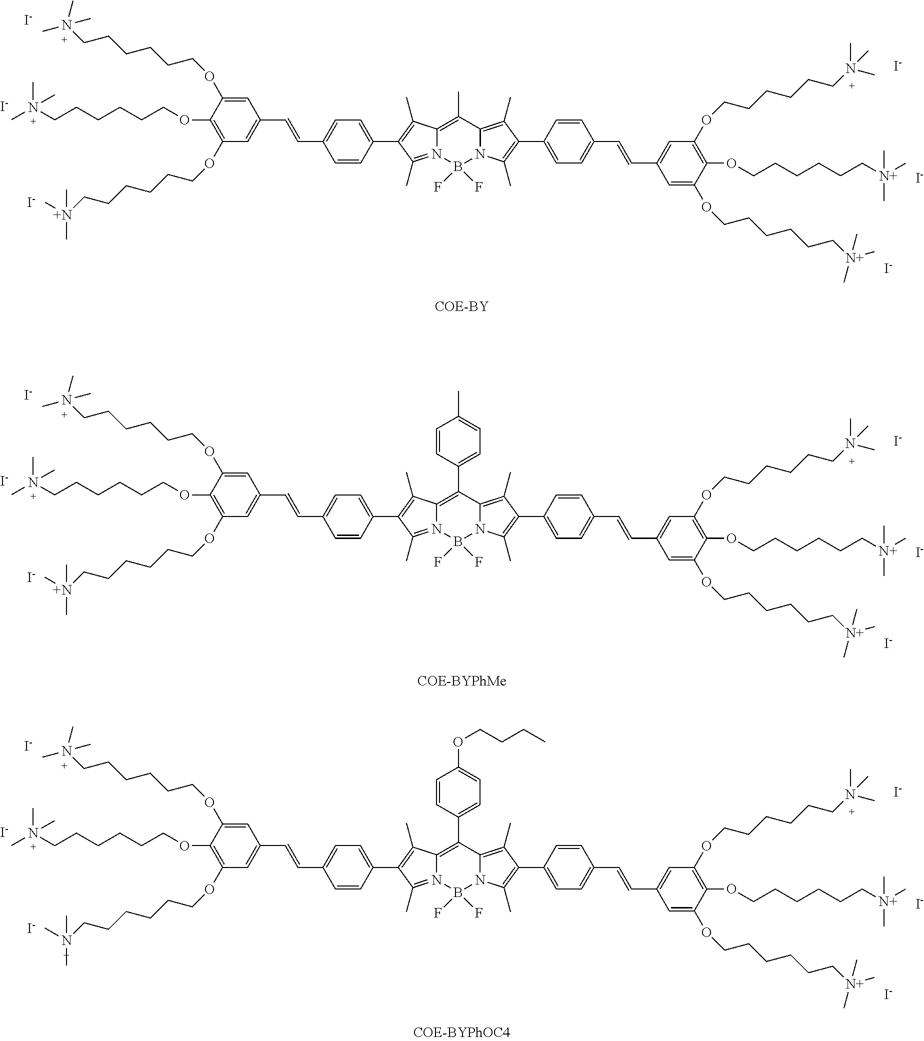

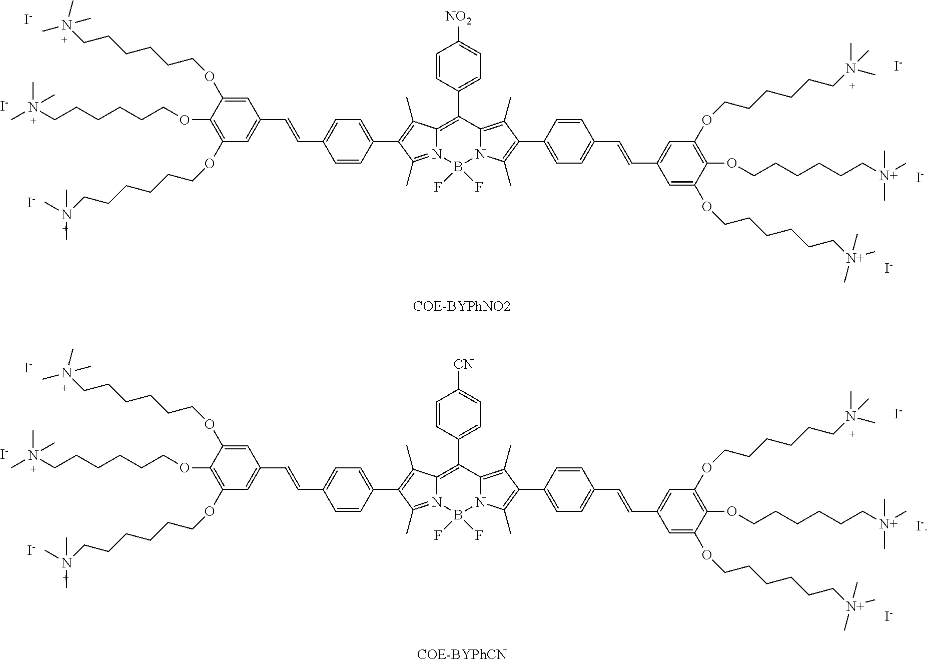

14. A method of staining a cell membrane and/or lipid vesicle, comprising contacting the compound of Formula (I) or a salt or solvate thereof according to claim 1 with the cell membrane and/or lipid vesicle.

15. A method of selectively staining a domain of a cell membrane and/or lipid vesicle, the domain having a higher viscosity relative to another region of the cell membrane and/or lipid vesicle, comprising contacting the compound of Formula (I) or a salt or solvate thereof according to claim 1 with the cell membrane and/or lipid vesicle.

16. The method according to claim 15, wherein the domain of the cell membrane and/or lipid vesicle is characterised by a presence of lipoprotein, glycolipoprotein and/or cholesterol.

17. The method according to claim 15, wherein the domain of the cell membrane and/or lipid vesicle having a having a higher relative viscosity is characterised by a relatively higher density of lipoprotein and/or cholesterol.

18. The method according to claim 14, wherein the cell membrane is from an adherent cell.

19. The method according to claim 14, wherein the contact period is about 1 min to about 12 days.

20. The method according to claim 14, wherein the compound of Formula (I) is characterised by a fluorescence lifetime which is linearly correlated with a viscosity of the domain.

21. The method according to claim 14, wherein the compound of Formula (I) is characterised by a fluorescence lifetime of about 1.1 ns to about 3 ns at a viscosity of about 900 cP to about 1200 cP.

22. A method of detecting a cell membrane and/or a lipid vesicle using a fluorescence detector, comprising:
a) contacting a compound of Formula (I) or a salt or solvate thereof according to claim 1 with the cell membrane and/or lipid vesicle; and
b) passing the cell membrane and/or lipid vesicle through the fluorescence detector.

23. A method of tracking endocytosis in a cell, comprising:
a) contacting a compound of Formula (I) or a salt or solvate thereof according to claim 1 with the cell; and
b) passing the cell through a fluorescence detector;
wherein the compound of Formula (I) is configured to exhibit an increasing fluorescence emission lifetime as it is internalised into the cell.

24. A flow system for detecting and/or quantifying cells membrane and/or lipid vesicle, comprising:
a) a compound of Formula (I) or a salt or solvate thereof according to claim 1 for labelling the cell membrane and/or lipid vesicle;
b) an inlet for introducing the labelled cell membrane and/or lipid vesicle into the flow system;
c) a detection means in fluid communication with the inlet for detecting a fluorescence emission from the labelled cell membrane and/or lipid vesicle; and
d) optionally a counter means for quantifying the labelled cell membrane and/or lipid vesicle.
